(19) United States
(12) Patent Application Publication
(10) Pub. No.: US 2015/0067555 A1
(43) Pub. Date: Mar. 5, 2015

(54) METHOD FOR CONFIGURING SCREEN AND ELECTRONIC DEVICE THEREOF

(71) Applicant: Samsung Electronics Co., Ltd., Suwon-si (KR)

(72) Inventors: Jong-Sung JOO, Seoul (KR); Joong-Hun KWON, Seoul (KR); Kyu-Chul KONG, Gumi-si (KR)

(21) Appl. No.: 14/456,387

(22) Filed: Aug. 11, 2014

(30) Foreign Application Priority Data
Aug. 28, 2013 (KR) 10-2013-0102744

(51) Int. Cl. G06F 3/0484; G06F 3/0481

(52) U.S. Cl. CPC G06F 3/04842; G06F 3/0481
USPC 715/765

(57) ABSTRACT

A method of an electronic device to configure a screen is provided. The method includes determining at least one area in a wallpaper displayed on the electronic device, selecting at least one content to be connected to the at least one determined area, and connecting the at least one selected content to the at least one determined area.

### CROSS-REFERENCE TO RELATED APPLICATION(S)

This application claims the benefit under 35 U.S.C. §119(a) of a Korean patent application filed on Aug. 28, 2013 in the Korean Intellectual Property Office and assigned Serial number 10-2013-0102744, the entire disclosure of which is hereby incorporated by reference.

### TECHNICAL FIELD

The present disclosure relates to a method for configuring a screen and an electronic device thereof.

### BACKGROUND

Electronic devices, which have become commonly used by modern people due to their portability, have developed into multimedia devices providing various services, such as voice and video call functions, information input/output functions, and data transmission functions.

At this point, the electronic devices may configure a home screen to include shortcut icons for various services in order to make an access to the various services stored in a memory easy. For example, the electronic devices may include at least one application icon on a home screen. For another example, the electronic devices may include at least one bookmark icon on a home screen. For another example, the electronic devices may include at least one contact icon on a home screen. Accordingly, the electronic devices provide services corresponding to each icon once a selection of the icon is detected.

As mentioned above, the home screen provided from the electronic devices provides only a configuration based on a predetermined arrangement and form. Therefore, the degree of freedom for home screen configuration is low.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages below. Accordingly, an aspect of the present disclosure is to provide a technique for configuring a home screen in an electronic device.

In accordance with an aspect of the present disclosure, a method of an electronic device to configure a screen is provided. The method includes determining at least one area in a wallpaper displayed on the electronic device, selecting at least one content to be connected to the at least one determined area, and connecting the at least one selected content to the at least one determined area.

In accordance with another aspect of the present disclosure, an electronic device is provided. The electronic device includes a display, and a processor configured to determine at least one area from a wallpaper displayed on the electronic device, to select at least one content to be connected to the at least one determined area, and to connect the at least one selected content to the at least one determined area.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device according to an embodiment of the present disclosure;

FIG. 2 is a block diagram illustrating a processor according to an embodiment of the present disclosure;

FIG. 3 is a flowchart illustrating a procedure for configuring a home screen in an electronic device according to an embodiment of the present disclosure;

FIG. 4 is a flowchart illustrating a procedure for setting a home screen on a wallpaper in an electronic device according to an embodiment of the present disclosure;

FIGS. 5A, 5B, 5C, 5D, 5E, 5F, 5G, 5H, and 5I are views illustrating a screen configuration for setting a wallpaper on a home screen on a basis of a menu operation in an electronic device according to an embodiment of the present disclosure;

FIGS. 6A, 6B, and 6C are views illustrating a screen configuration for setting a wallpaper on a home screen on a basis of a gesture in an electronic device according to an embodiment of the present disclosure;

FIGS. 7A, 7B, 7C, 7D, 7E, and 7F are views illustrating a screen configuration for setting at least one of a size, a position, and a tilt of a wallpaper set on a home screen in an electronic device according to an embodiment of the present disclosure;

FIGS. 8A and 8B are views illustrating a screen configuration for determining an overall size of a wallpaper set on a home screen in an electronic device according to an embodiment of the present disclosure;

FIGS. 9A and 9B are views illustrating a screen configuration for determining a size of a partial area in a wallpaper set on a home screen in an electronic device according to an embodiment of the present disclosure;

FIG. 10A is a flowchart illustrating a procedure for configuring a home screen after an electronic device determines a template as a wallpaper according to an embodiment of the present disclosure;

FIG. 10B is a flowchart illustrating a procedure for configuring a home screen after an electronic device determines an image as a wallpaper according to an embodiment of the present disclosure;

FIGS. 11A, 11B, 11C, and 11D are views illustrating a screen configuration for configuring a home screen in an electronic device according to an embodiment of the present disclosure;

FIGS. 12A, 12B, 12C, and 12D are views illustrating a screen configuration when a configuration of a home screen is completed in an electronic device according to an embodiment of the present disclosure;

FIG. 13A is a flowchart illustrating a procedure for editing a home screen in an electronic device according to an embodiment of the present disclosure;

FIG. 13B is a flowchart illustrating a procedure for modifying a home screen in an electronic device according to an embodiment of the present disclosure;

FIGS. 14A, 14B, 14C, 14D, 14E, and 14F are views illustrating a screen configuration for editing a home screen in an electronic device according to an embodiment of the present disclosure;

FIGS. 15A, 15B, and 15C are views illustrating a screen configuration for setting a wallpaper on a home screen in an electronic device according to an embodiment of the present disclosure;

FIGS. 16A and 16B are views illustrating a screen configuration for determining an overall size of a wallpaper set on a home screen in an electronic device according to an embodiment of the present disclosure;

FIGS. 17A and 17B are views illustrating a screen configuration for determining a size of a partial area in a wallpaper set on a home screen in an electronic device according to an embodiment of the present disclosure;

FIGS. 18A, 18B, 18C, and 18D are views illustrating a screen configuration for configuring a home screen in an electronic device according to an embodiment of the present disclosure;

FIGS. 19A, 19B, 19C, and 19D are views illustrating a screen configuration when a configuration of a home screen is completed in an electronic device according to an embodiment of the present disclosure; and

FIGS. 20A, 20B, 20C, 20D, 20E, and 20F are views illustrating a screen configuration for editing a home screen in an electronic device according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

An electronic device, according to various embodiments of the present disclosure, may be at least one or a combination of various devices including smart phones, tablet personal computers (PCs), mobile phones, video phones, e-book readers, desktop PCs, laptop PCs, netbook computers, personal digital assistants (PDAs), portable multimedia players (PMPs), motion picture expert group (MPEG) audio layer-3 (MP3) players, mobile medical equipment, electronic bracelets, electronic collars, e-accessories, cameras, wearable devices, electronic watches, wrist watches, smart appliances, e.g., refrigerators, air conditioners, vacuum cleaners, artificial intelligence robots, TVs, digital versatile disc (DVD) players, audios, ovens, microwaves, washing machines, air purifiers, and electronic frames, various medical devices, e.g., magnetic resonance angiography (MRA), magnetic resonance imaging (MRI), computerized tomography (CT), camcorders, and ultrasonic devices, navigation devices, global positioning system (GPS) receivers, event data recorders (EDRs), flight data recorders (FDRs), set-top boxes, TV boxes, e.g., Samsung HomeSync™, Apple TV™, or Google TV™, electronic dictionaries, automotive infotainment devices, marine electronic equipment, e.g., marine navigation systems and gyroscopic compasses, avionics equipment, security equipment, electronic garments, electronic keys, camcorders, game consoles, head-mounted displays (HMDs), flat panel displays, electronic albums, furniture and/or part of a building/structure including communication functions, electronic boards, electronic signature input devices, or projectors. It is apparent to those skilled in the art that an electronic device according to various embodiments of the present disclosure is not limited to the above devices.

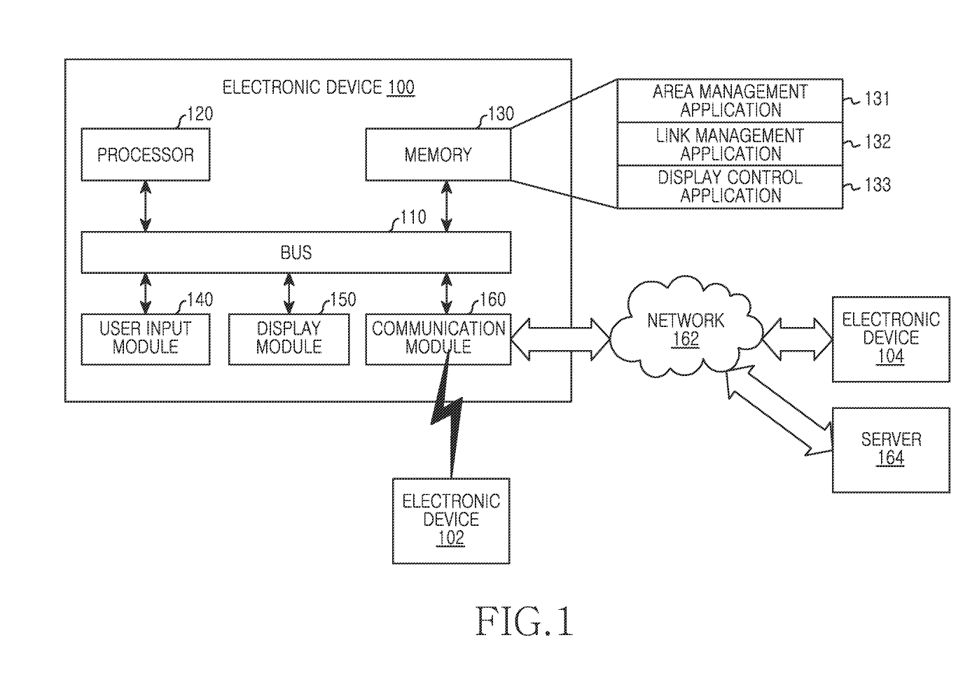

FIG. 1 is a block diagram illustrating an electronic device according to an embodiment of the present disclosure.

Referring to FIG. 1, the electronic device 100 may include a bus 110, a processor 120, a memory 130, a user input module 140, a display module 150, and a communication module 160.

The bus 110 may be a circuit that connects components, for example, the bus 110, the processor 120, the memory 130, the user input module 140, the display module 150, and the communication module 160, and delivers a communication, for example, a control message, between the components.

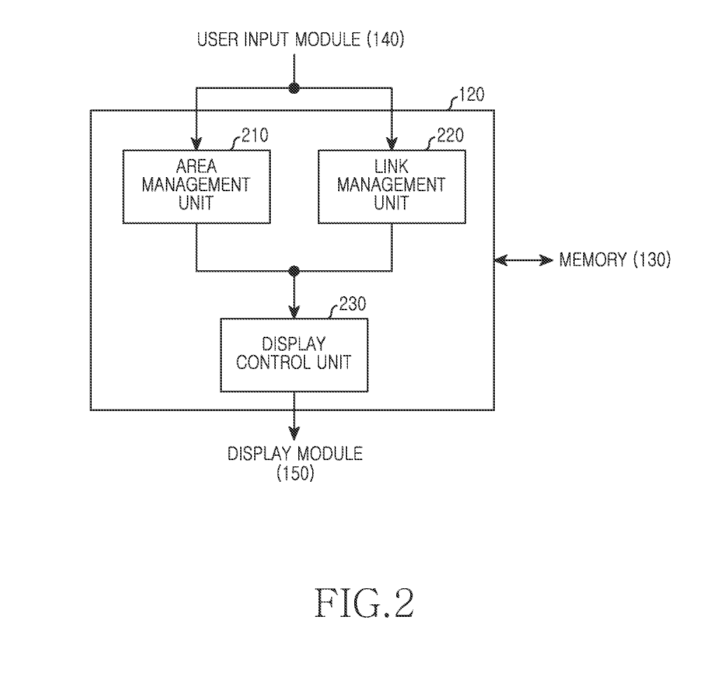

The processor 120 may receive an instruction from components included in the electronic device 100 through the bus 110, may interpret the received instruction, and may perform operations and/or data processing according to the interpreted instruction. At this point, the processor 120 controls providing a service according to a corresponding application by executing at least one application stored in the memory 130. For example, the processor 120 may be configured as shown in FIG. 2 in order to control a home screen configuration by executing an area management application 131, a link management application 132, and a display control application 133.

The processor 120 may include at least one application processor (AP) (not shown) and/or at least one communication processor (CP) (not shown). Here, an AP or a CP may be included in a processor 120 and/or different integrated circuit (IC) packages, respectively. Additionally, an AP or a CP may be included in one IC package. The AP may control a plurality of hardware and/or software components connected to the AP and may perform various data processing and/or operations including multimedia data by executing an operating system and/or application program. Here, the AP may be implemented with a system on chip (SoC). Additionally, the CP may perform at least part of a multimedia control function. Additionally, the CP may perform distinction and authentication of a terminal in a communication network by using a subscriber identification module (SIM) card. At this point, the CP may provide a service including a voice call, a video call, a text message, and/or packet data to a user. Additionally, the CP may control the data transmission of the communication module 160. The AP and/or CP may load an instruction or data received from at least one of nonvolatile memory and another component connected thereto into volatile memory and may then process the loaded data. Moreover, the AP or CP may store data received and/or generated from at least one of other components in nonvolatile memory. The CP may perform a function of managing a data link and converting a communication protocol in communication between other electronic devices, connected to an electronic device including hardware, through a network. Here, the CP may be implemented with a SoC. Additionally, the processor 120 may further include a graphic processing unit (GPU).

The memory 130 may store an instruction and/or data received from the processor 120 and/or other components, for example, the user input module 140, the display module 150, and the communication module 160, and/or an instruction and/or data generated from the processor 120 and/or other components. At this point, the memory may include an internal buffer (not shown) and an external buffer (not shown).

Additionally, the memory 130 may include the area management application 131, the link management application 132, and the display control application 133. At this point, each application may be configured with a programming module and may be configured with at least one of software, firmware, hardware, and/or a combination thereof.

The area management application 131 includes at least one software component for releasing a determination and a selection of an area in a wallpaper of a home screen. For example, when a template, which may be stored in the memory 130, is set as a wallpaper, the area management application 131 may confirm which area is selected by a user from among predetermined areas in the template. For another example, when an image is set as a wallpaper through an application providing a background setting, the area management application 131 may determine an area in the image set as the wallpaper on a basis of, or in other words, according to, a user's selection.

The link management application 132 includes at least one software component for linking content to an area in a wallpaper of a home screen. For example, when an event for linking content to an area occurs, the link management application 132 may request displaying of a content linkable to an area from the display control application 133. For example, when an event for linking content to an area occurs, the link management application 132 may request displaying of a content linkable to an area from the display control application 133. At this point, the link management application 132 may request displaying of an application list from the display control application 133. For another example, the link management application 132 may request displaying of at least one contact on an area from the display control application 133. At this point, the link management application 132 may request displaying of a contact list from the display control application 133. For another example, the link management application 132 may request displaying of at least one bookmark linkable to an area from the display control application 133. At this point, the link management application 132 may request displaying of a bookmark list from the display control application 133. Accordingly, the link management application 132 may connect at least one content from among linkable contents on the basis of, or in other words, according to, a user's selection.

The display control application 133 includes at least one software component for displaying a home screen through the display module 150. For example, the display control application 133 may display content linkable to an area according to a request of the link management application 132. For example, the display control application 133 may display at least one application linkable to an area according to a request of the link management application 132. At this point, the display control application 133 may display an application list according to a request of the link management application 132. For another example, the display control application 133 may display at least one contact linkable to an area according to a request of the link management application 132. At this point, the display control application 133 may display a contact list according to a request of the link management application 132. For another example, the display control application 133 may display at least one bookmark linkable to an area according to a request of the link management application 132. At this point, the display control application 133 may display an application list according to a request of the link management application 132.

Additionally, the memory 130 may include an internal memory or an external memory. The internal memory may include at least one of a volatile memory, for example, random access memory (RAM) dynamic RAM (DRAM), static RAM (SRAM), and synchronous dynamic RAM (SDRAM), and a nonvolatile memory, for example, read only memory (ROM), programmable ROM (PROM), one-time PROM (OTPROM), erasable PROM (EPROM), electrically erasable PROM (EEPROM), mask ROM, flash ROM, NAND flash memory, and NOR flash memory. At this point, the internal memory may have a form of a solid state drive (SSD). The external memory may include at least one of a compact flash (CF) memory, a secure digital (SD) memory, a Micro-SD memory, a Mini-SD memory, an xD memory, and a memory stick.

Additionally, the memory 130 may further include a kernel, a middleware, and an application programming interface (API). The kernel may control and/or manage system resources, for example, the bus 110, the processor 120, or the memory 130, used for executing an operation and/or a function implemented in the remaining other programming modules, for example, the middleware, the API and/or an application. Additionally, the kernel may provide an interface for accessing an individual component of the electronic device 100 and controlling and managing the individual component in middleware, an API, and/or an application. The middleware may perform an intermediary role to allow an API and/or an application to communicate with the kernel so as to exchange data. Additionally, the middleware may perform load balancing on a task request through a method of assigning a priority for using a system resource, for example, the bus 110, the processor 120, and the memory 130, of the electronic device 100 to task requests received from at least one application. The API, as an interface through which an application controls a function provided from the kernel and/or the middleware, may include at least one interface and/or function for controlling file control, window control, image processing and/or character control.

The user input module 140 may receive an instruction and/or data from a user and deliver it to the processor 120 and/or the memory 130 through the bus 110. For example, the user input module 140 may include a touch panel, a pen sensor, a key, and/or an ultrasonic input device. For example, the touch panel may recognize a touch input through at least one of a capacitive, a resistive, an infrared and an ultrasonic method. Here, the touch panel may further include a controller. In the case of the capacitive method, direct touch and close recognition are possible. The touch panel may further include a tactile layer. At this point, the touch panel may provide a tactile response to a user. For example, the pen sensor may be implemented using the same and/or similar method as receiving a touch input of a user and/or an additional sheet for recognition. For example, the key may include a keypad and/or a touch key. For example, the ultrasonic input device is a device detecting a micro sound wave through a pen generating an ultrasonic signal and confirming data and also radio frequency recognition is possible.

The display module 150 may display an image, a video, and/or data to a user. For example, the display module 150 may include a panel and/or a hologram. For example, the panel may be a liquid crystal display (LCD) panel or an active matrix-organic light emitting diode (AM-OLED) display panel. Additionally, the panel may be implemented to be flexible, transparent, and/or wearable. Here, the panel and the touch panel may be configured with one module. For example, the hologram may show 3 dimensional (3D) images in the air by using an interference of light. Additionally, the display module 150 may further include a control circuit for controlling a panel and/or a hologram.

Additionally, the display module 150 may display a home screen according to a control of the display control application 133. For example, the display module 150 may display content linkable to an area. For example, the display module 150 may display at least one application linkable to an area. At this point, the display module 150 may display an application list. For another example, the display module 150 may display at least one contact linkable to an area. At this point, the display module 150 may display a contact list. For another example, the display module 150 may display at least one bookmark linkable to an area. At this point, the display module 150 may display a bookmark list.

The communication module 160 may connect, or in other words, for a communication link, between the electronic device 100 and other electronic devices 102 and 104 and/or a server 164 via a network 162. At this point, the communication module 160 may support a short range communication protocol, for example, Wi-Fi, bluetooth (BT), and/or near field communications (NFC), and/or a network communication, for example, the Internet, a local area network (LAN), a wide area network (WAN), a telecommunication network, a cellular network, a satellite network and/or a plain old telephone system (POTS).

Each of the other electronic devices 102 and 104 may be a device identical to, a same type as, and/or different from the electronic device 100.

Additionally, the electronic device 100 may further include at least one sensor module (not shown). The sensor module may include at least one of a gesture sensor, a gyroscopic sensor, a pressure sensor, a magnetic sensor, an acceleration sensor, a grip sensor, a proximity sensor, a red green blue (RGB) sensor, a bio sensor, a temperature/humidity sensor, an illumination sensor, and/or an ultraviolet (UV) sensor. Additionally, the sensor module measures physical quantities and/or detects an operating state of an electronic device, thereby converting the measured and/or detected information into electrical signals. For example, the sensor module 180 may include an E-nose sensor, an electromyography (EMG) sensor, an electroencephalogram (EEG) sensor, an electrocardiogram (ECG) sensor, and/or a fingerprint sensor. Additionally, the sensor module may further include a control circuit for controlling at least one sensor included in the electronic device 100.

The names of the above-mentioned components in hardware according to various embodiments of the present disclosure may vary according to types of an electronic device. Hardware according to an embodiment of the present disclosure may be configured including at least one of the above-mentioned components and/or additional other components. Also, some components may be omitted. Additionally, some of components in hardware according to various embodiments of the present disclosure are configured as one entity, so that functions of previous corresponding components are performed identically.

FIG. 2 is a block diagram illustrating a processor according to an embodiment of the present disclosure.

Referring to FIG. 2, the processor 120 includes an area management unit 210, a link management unit 220, and a display control unit 230. For convenience of description in this disclosure, although the processor 120 including the area management unit 210, the link management unit 220, and the display control unit 230 is described, even if the area management unit 210, the link management unit 220, and the display control unit 230 are not included in the processor 120, the processor 120 itself may perform functions below. The processor 120 may be referred to as a control unit.

The area management unit 210 may control releasing results of a determination and selection of an area in a wallpaper of a home screen by executing the area management application 131 stored in the memory 130. For example, when a template is set as a wallpaper, the area management unit 210 may confirm which area is selected by a user from predetermined areas in the template. For another example, when an image is set as a wallpaper through an application providing a background setting, the area management unit 210 may determine an area in the image set as the wallpaper on the basis of a user's selection.

The link management unit 220 may control linking content to an area in a wallpaper of a home screen by executing the link management application 132 stored in the memory 130. For example, when an event for linking content to an area occurs, the link management unit 220 may request displaying of content linkable to an area from the display control unit 230. For example, when an event for linking content to an area occurs, the link management application 220 may request displaying of content linkable to an area from the display control application 230. At this point, the link management unit 220 may request displaying of an application list from the display control unit 230. For another example, the link management unit 220 may request displaying of at least one contact linkable to an area from the display control application 230. At this point, the link management unit 220 may request displaying of a contact list from the display control unit 230. For another example, the link management unit 220 may request displaying of at least one bookmark linkable to an area from the display control unit 230. At this point, the link management unit 220 may request displaying of a bookmark list from the display control unit 230. Accordingly, the link management unit 220 may connect at least one content, from among linkable contents, on the basis of a user's selection.

The display control unit 230 may control displaying a home screen through the display module 150 by executing the display control application 113 stored in the memory 130. For example, the display control unit 230 may display content linkable to an area according to a request of the link management unit 220. For example, the display control unit 230 may display at least one application linkable to an area according to a request of the link management unit 220. At this point, the display control unit 230 may display an application list according to a request of the link management unit 220. For another example, the display control unit 230 may display at least one contact linkable to an area according to a request of the link management unit 220. At this point, the display control unit 230 may display a contact list according to a request of the link management unit 220. For another example, the display control unit 230 may display at least one bookmark linkable to an area according to a request of the link management unit 220. At this point, the display control unit 230 may display a bookmark list according to a request of the link management unit 220.

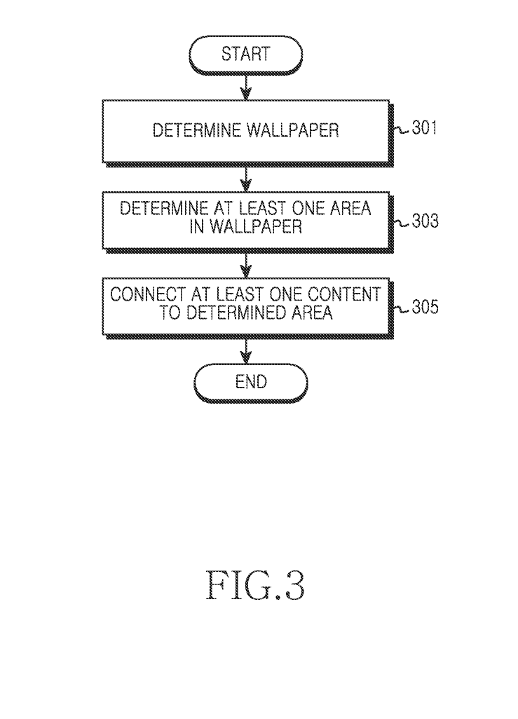

FIG. 3 is a flowchart illustrating a procedure for configuring a home screen in an electronic device according to an embodiment of the present disclosure.

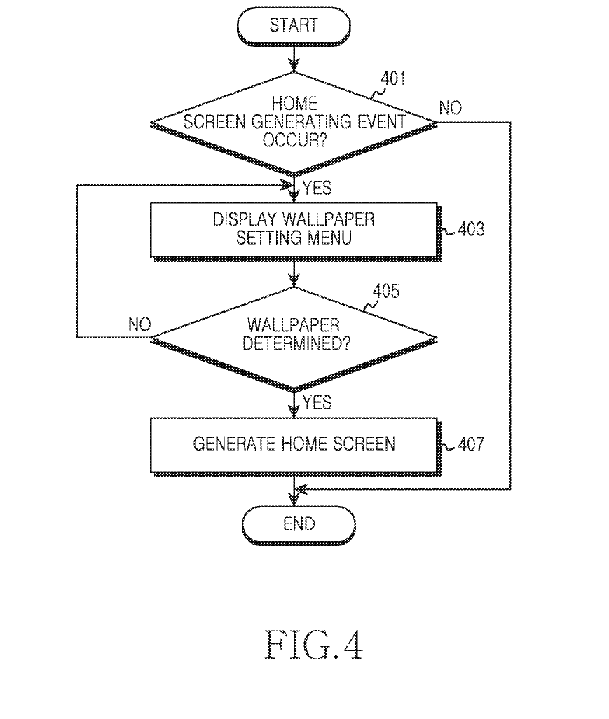

Referring to FIG. 3, the electronic device 100 determines a wallpaper of a home screen in operation 301. For example, when a home screen generating event occurs, the electronic device 100 displays a wallpaper setting menu. Here, the electronic device 100 may include at least one application list providing a template and a background setting on the wallpaper setting menu. Here, an application providing a background setting may be an application providing display data, for example, an image viewer, a document viewer, a web viewer, and a video viewer. For example, the electronic device 100 may determine a wallpaper through at least one application list providing a template and a background setting on the basis of a user's selection. An embodiment of determining a wallpaper of a home screen in an electronic device 100 is described in detail with reference to FIG. 4.

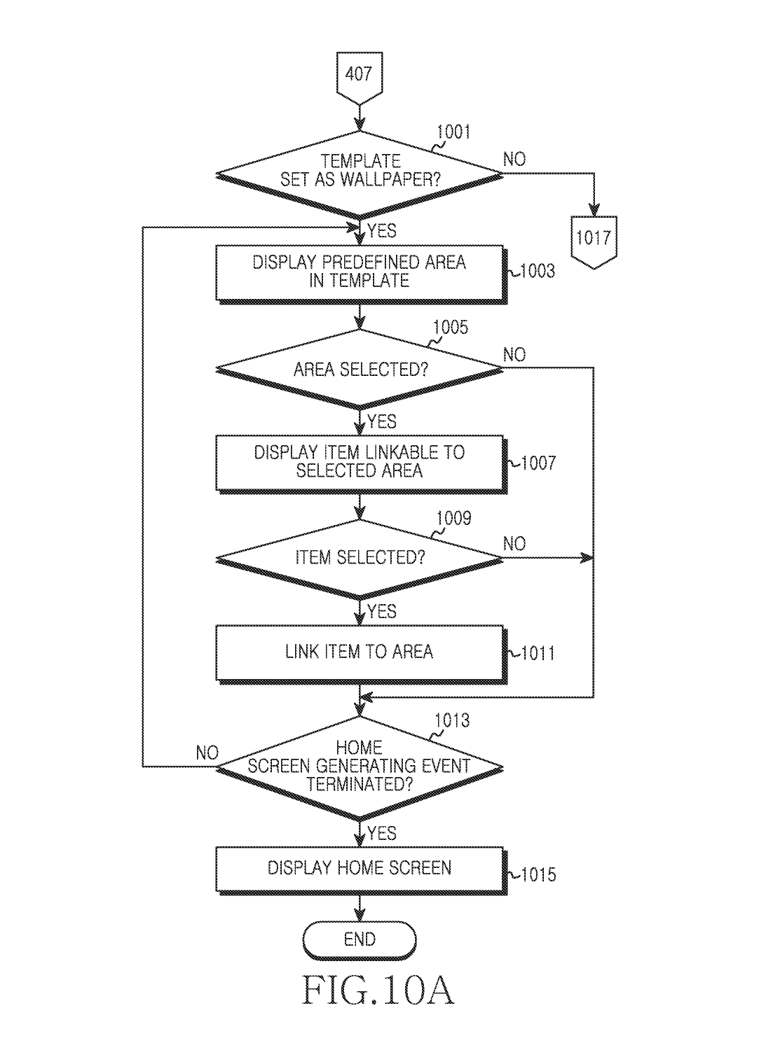

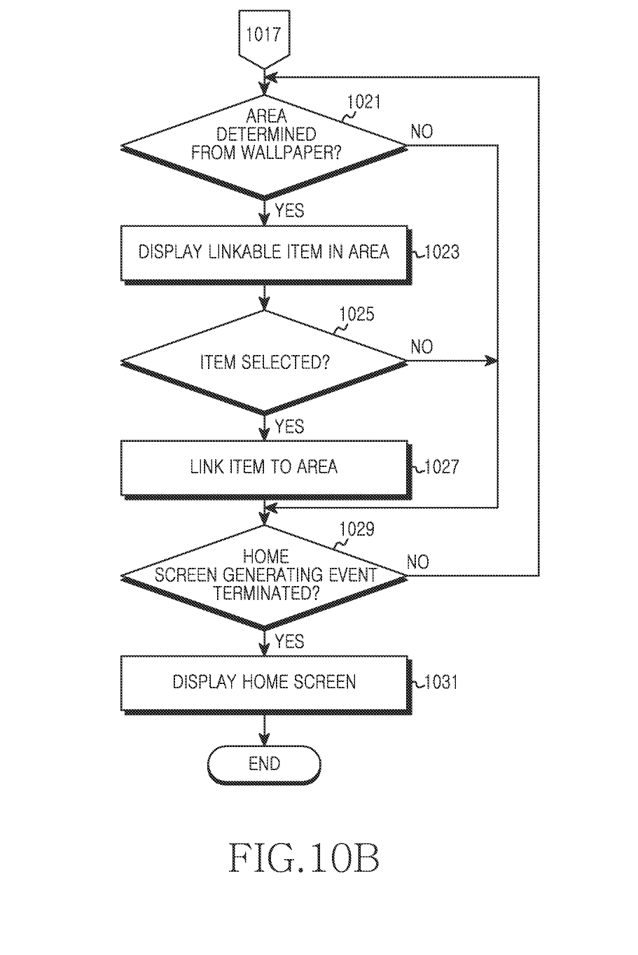

In operation 303, the electronic device 100 determines at least one area in and/or from the wallpaper. For example, when a template is set as a wallpaper, the electronic device 100 may confirm which area is selected by a user from among predetermined areas in the template. For another example, when an image is set as a wallpaper through an application providing a background setting, the electronic device 100 may determine an area in the image set as the wallpaper on the basis of a user's selection. An embodiment of determining at least one area from a wallpaper in an electronic device 100 is described in detail with reference to FIGS. 10A and 10B.

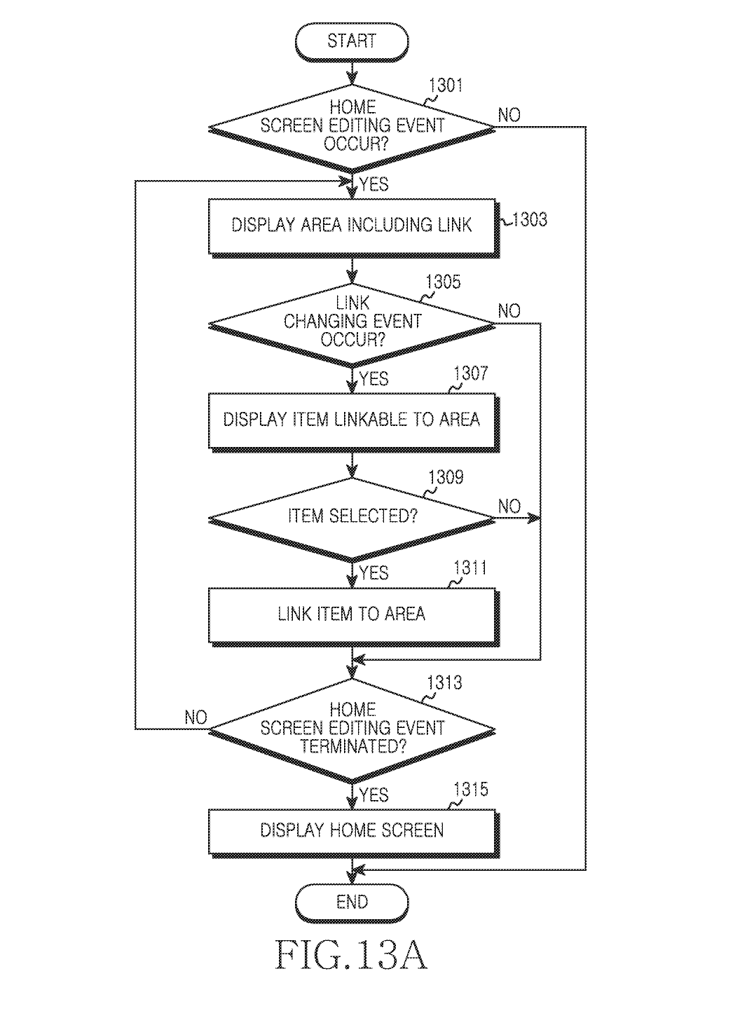

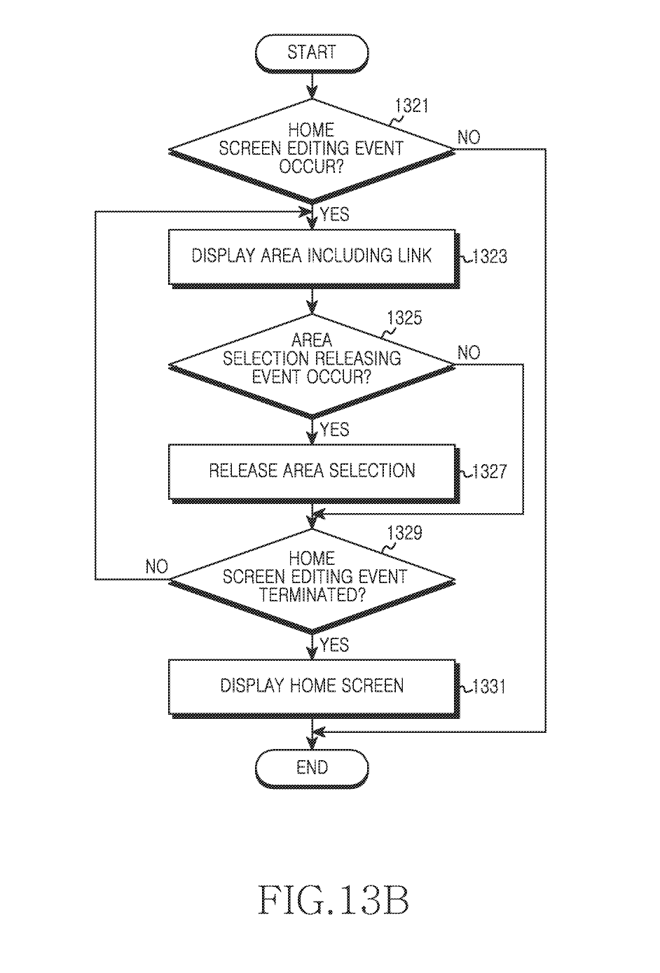

In operation 305, the electronic device 100 connects at least one content to the determined area. For example, the electronic device 100 may display content linkable to the determined area. For example, the electronic device 100 may display at least one application linkable to the determined area. At this point, the electronic device 100 may display an application list. For another example, the electronic device 100 may display at least one contact linkable to the determined area. At this point, the electronic device 100 may display a contact list. For another example, the electronic device 100 may display at least one bookmark linkable to the determined area. At this point, the electronic device 100 may display a bookmark list. Accordingly, the electronic device 100 may connect at least one content among linkable contents on the basis of a user's selection. An embodiment of the present disclosure, describing connecting of at least one content to an area in an electronic device 100, is described in detail with reference to FIGS. 10A and 10B and FIGS. 13A and 13B.

Then, after operation 305, the electronic device 100 terminates this algorithm.

FIG. 4 is a flowchart illustrating a procedure for setting a home screen on a wallpaper in an electronic device according to an embodiment of the present disclosure.

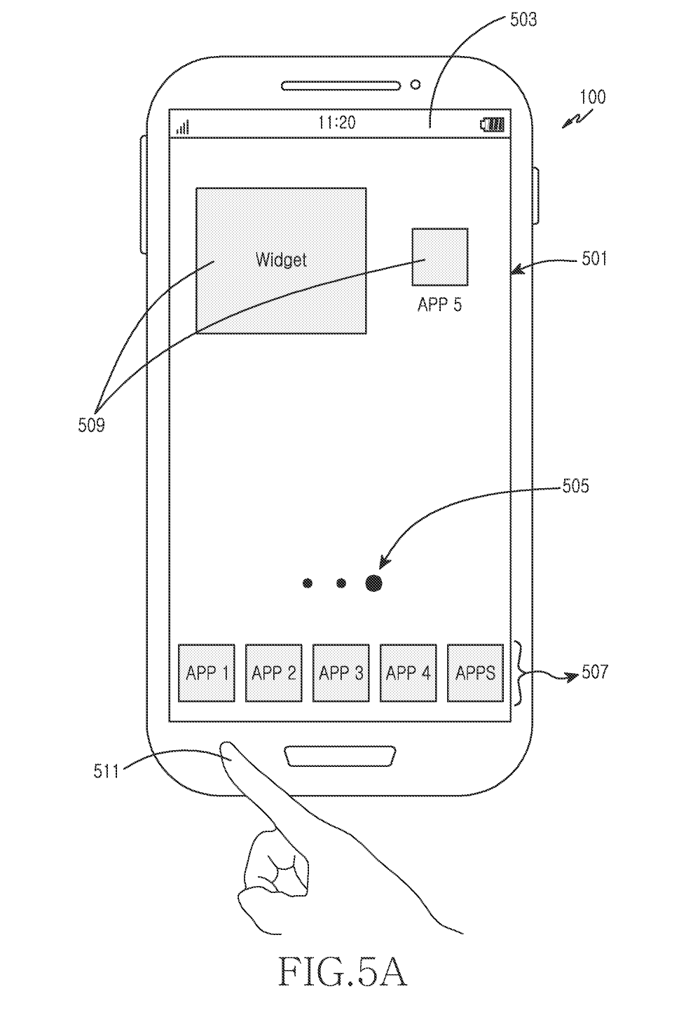

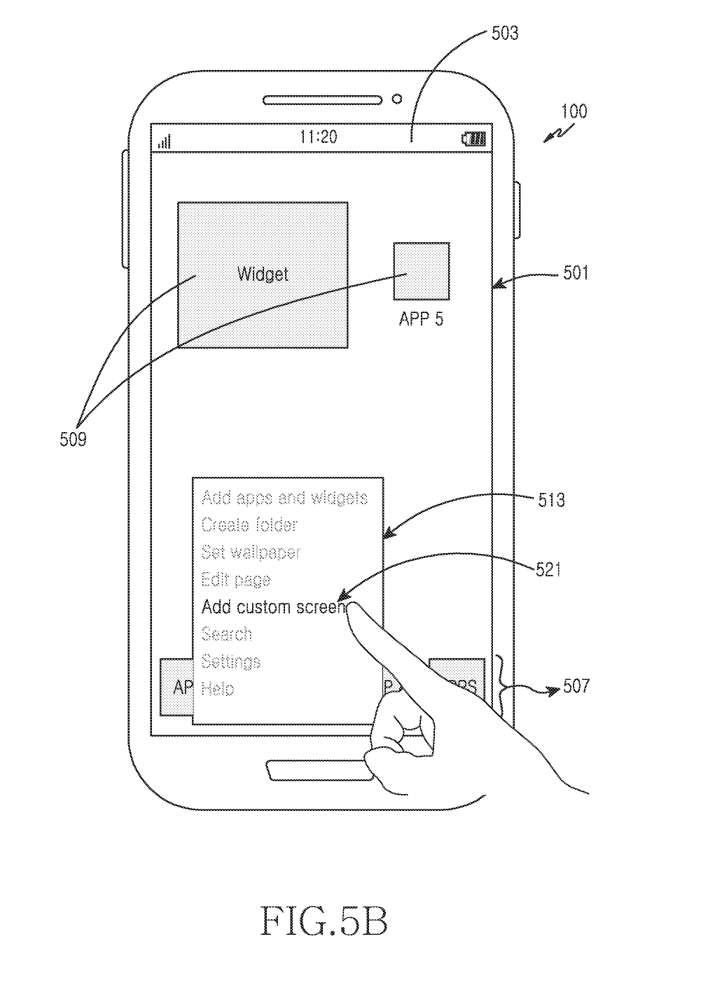

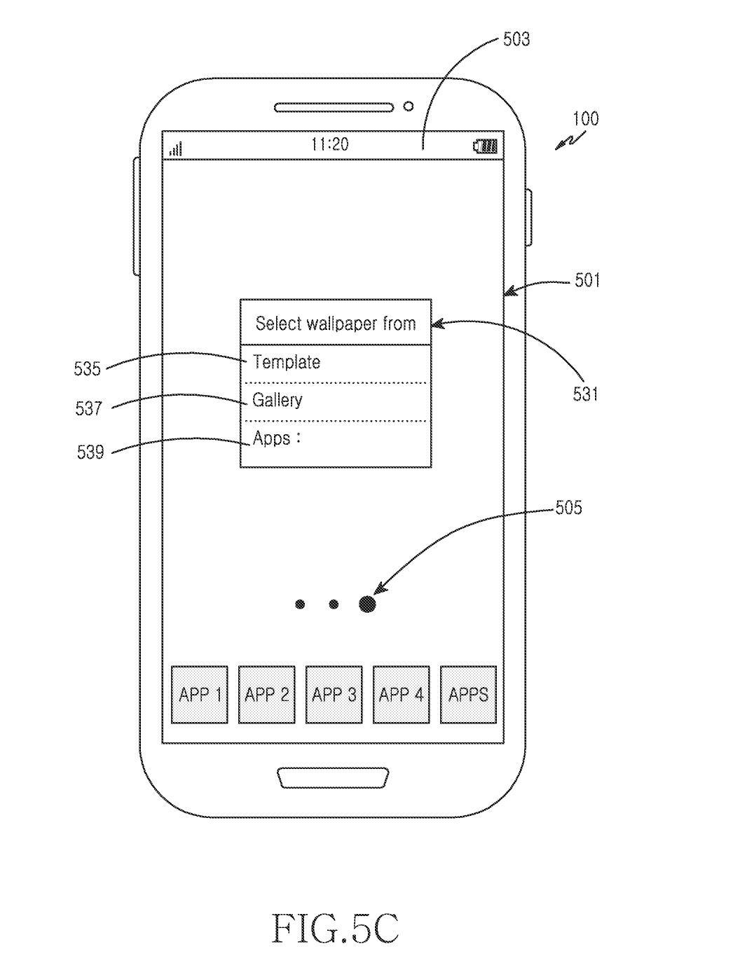

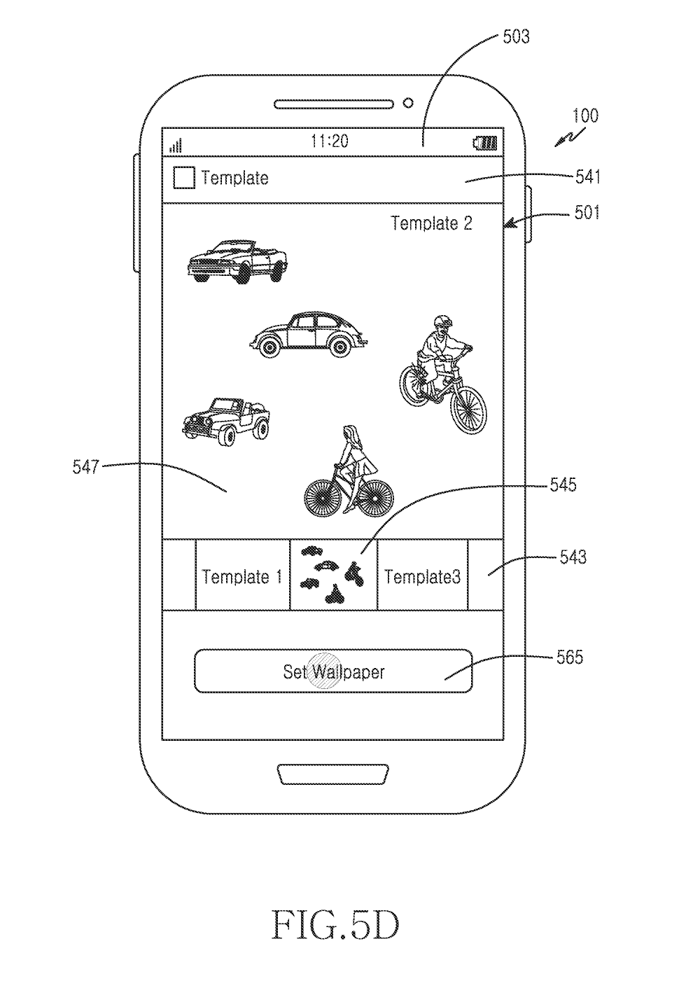

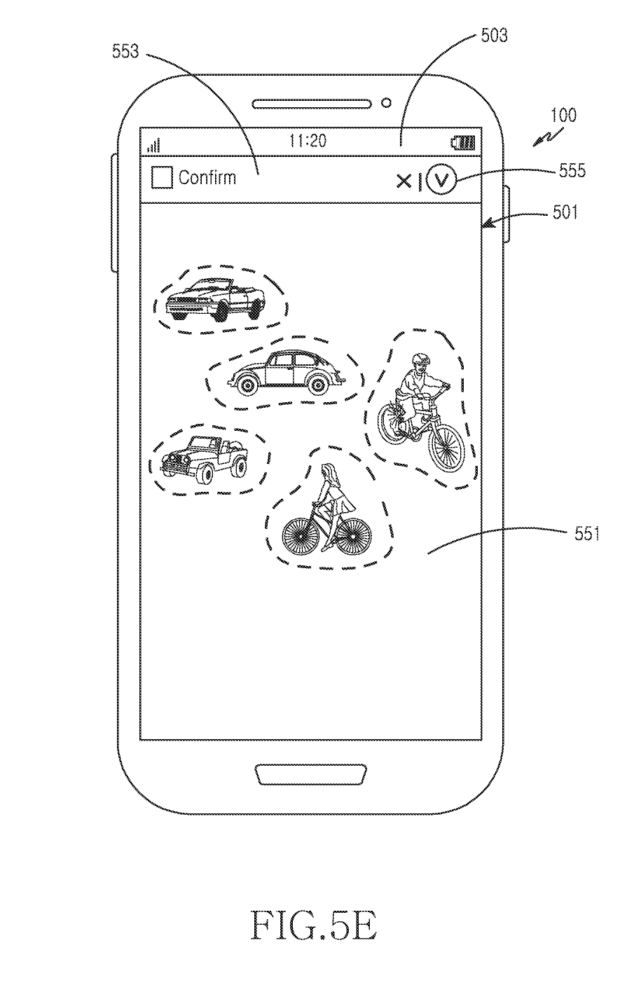

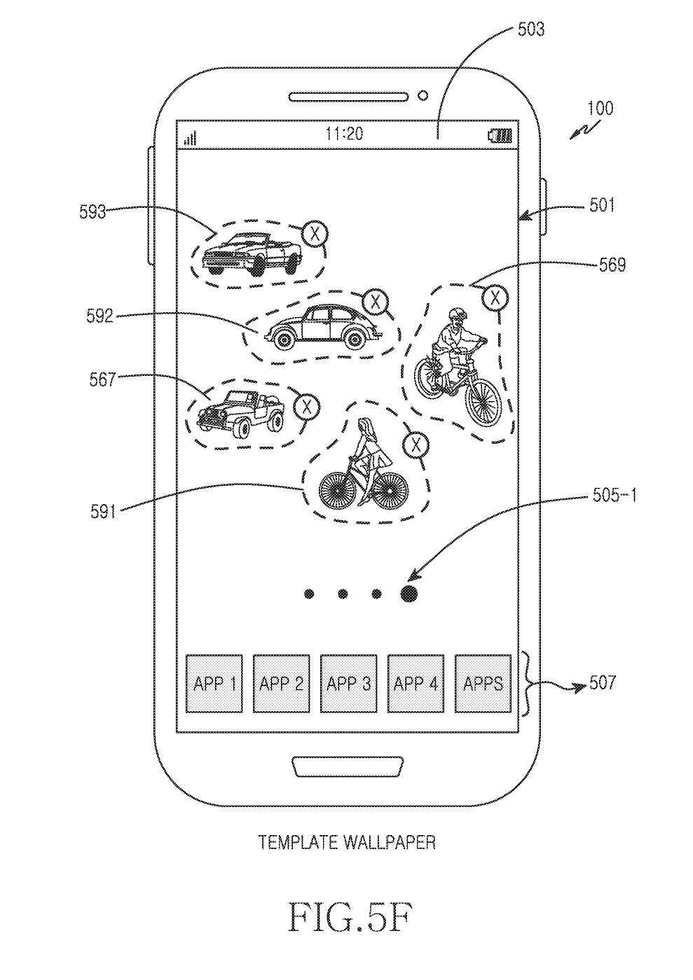

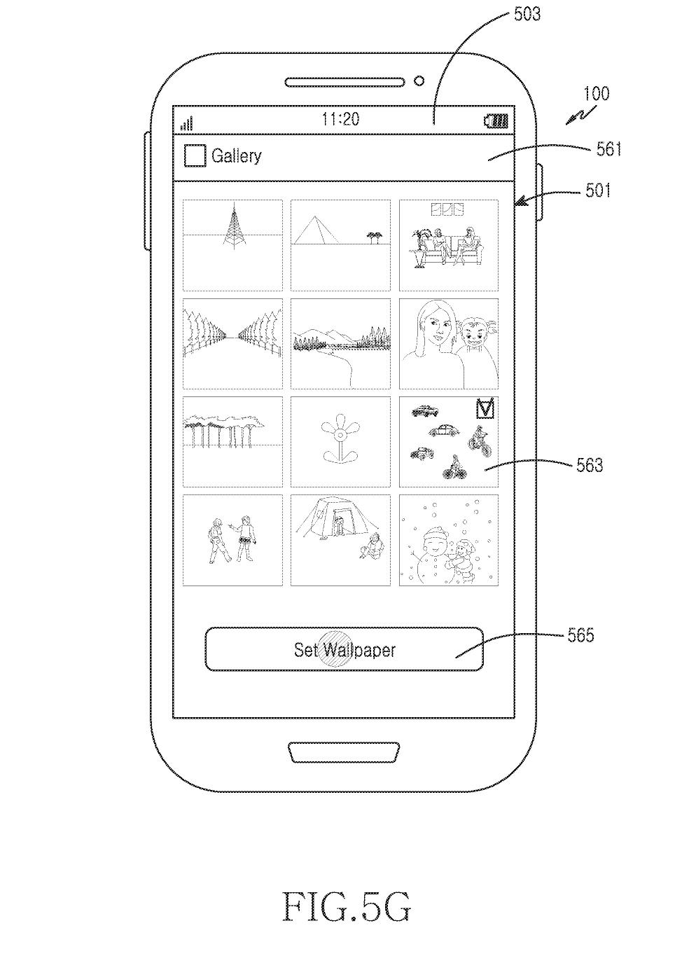

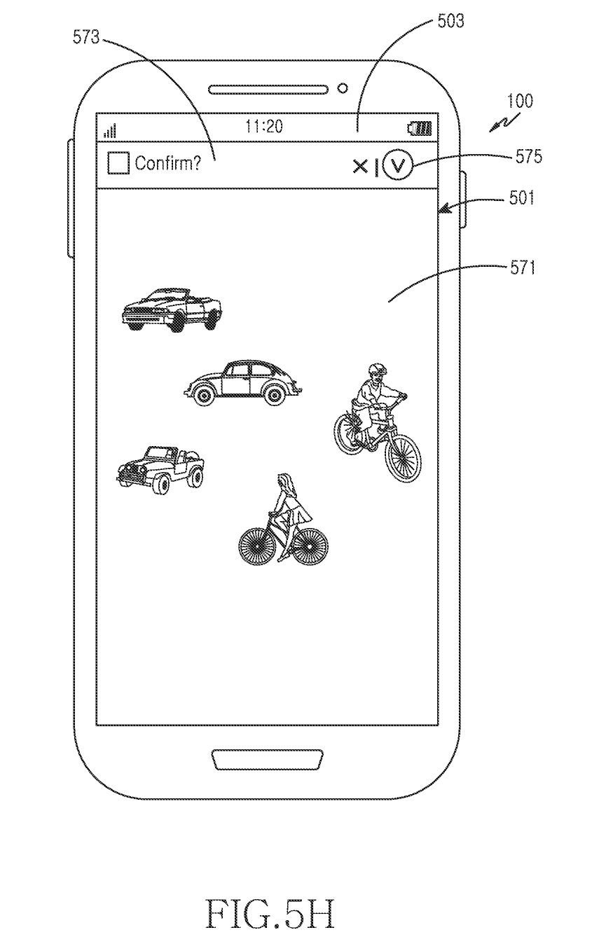

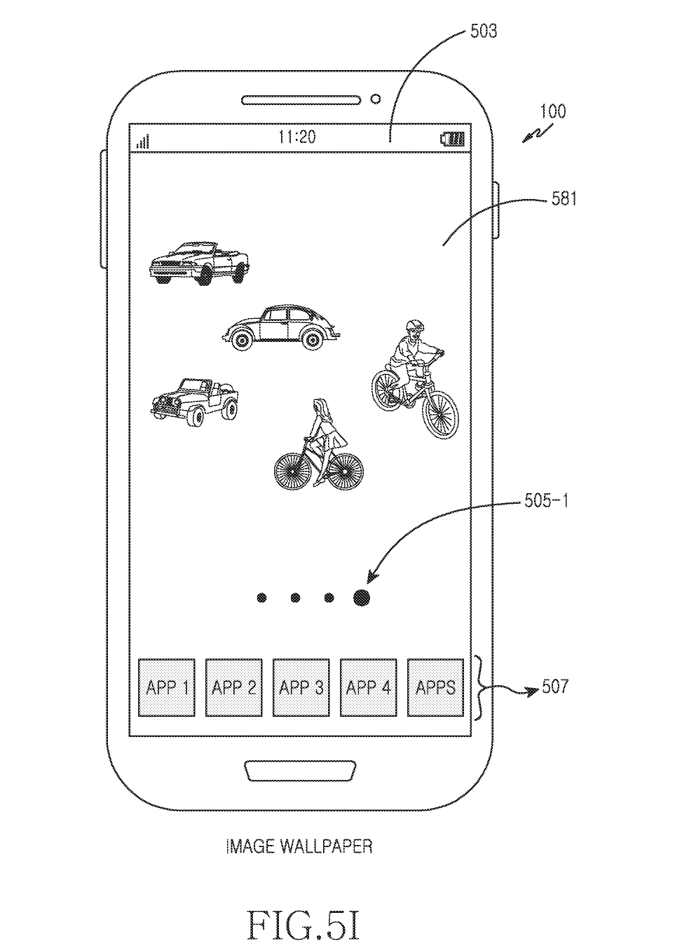

FIGS. 5A, 5B, 5C, 5D, 5E, 5F, 5G, 5H, and 5I are views illustrating a screen configuration for setting a wallpaper on a home screen on the basis of a menu operation in an electronic device according to an embodiment of the present disclosure.

Referring to FIGS. 4, 5A, 5B, 5C, 5D, 5E, 5F, 5G, 5H, and 5I, the electronic device 100 confirms whether the home screen generating event occurs in operation 401. For example, as shown in FIG. 5A, the electronic device 100 displays a home screen on a display unit 501. At this point, the electronic device 100 may include icons 509, for a widget and an application, on the home screen and also may include at least one application icon on a dock bar 507. Additionally, the electronic device 100 may include a status bar 503 on the display unit 501 and the status bar 503 may be hidden or displayed from a hidden status again on the basis of a system setting. Additionally, the electronic device 100 may display a number of pages and the position of a current page on the home screen as indicated by icon 505. When a menu button 511 is selected by a user, the electronic device 100 may display a menu list 513 in a pop-up window, as shown in FIG. 5B. At this point, when a home screen generating item 521 is selected from the menu list 513, the electronic device 100 determines that a new page is created on a home screen.

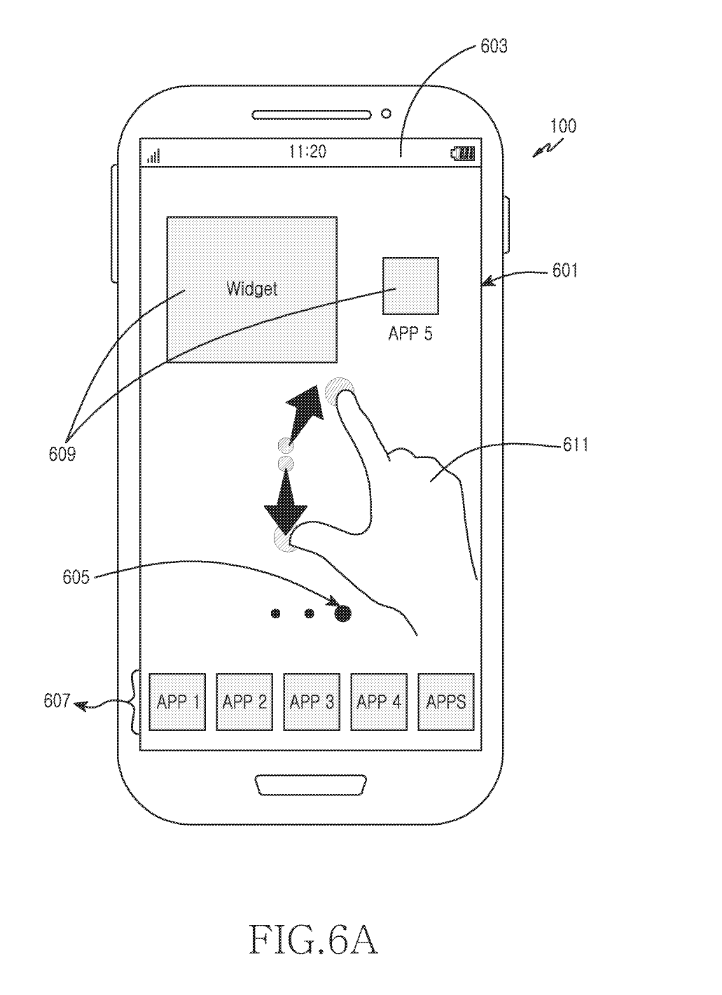

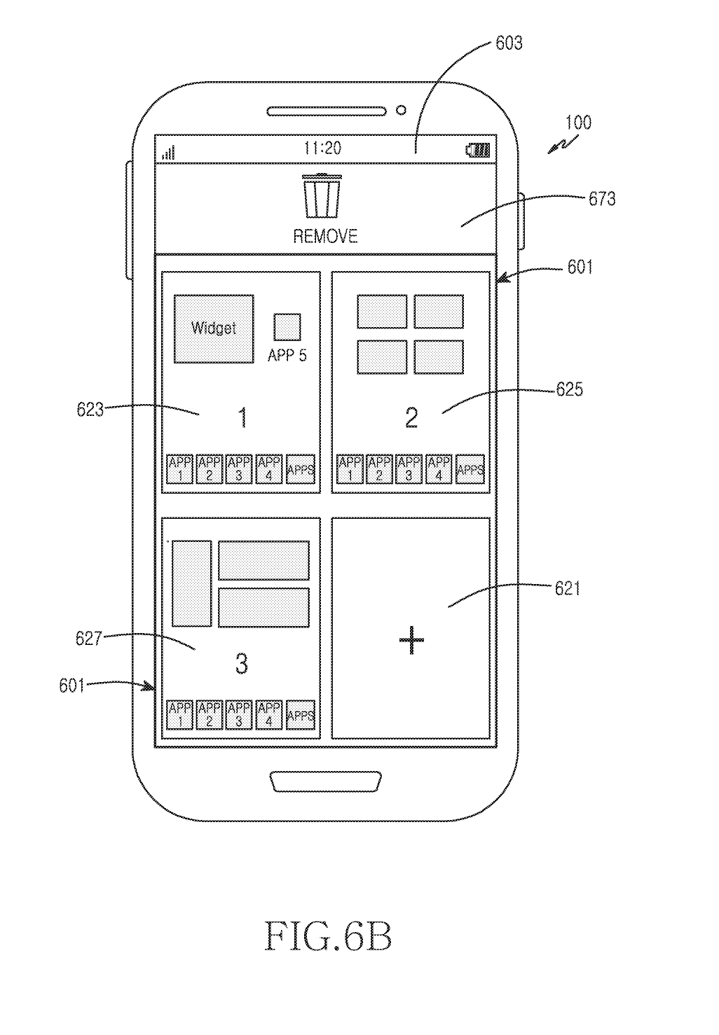

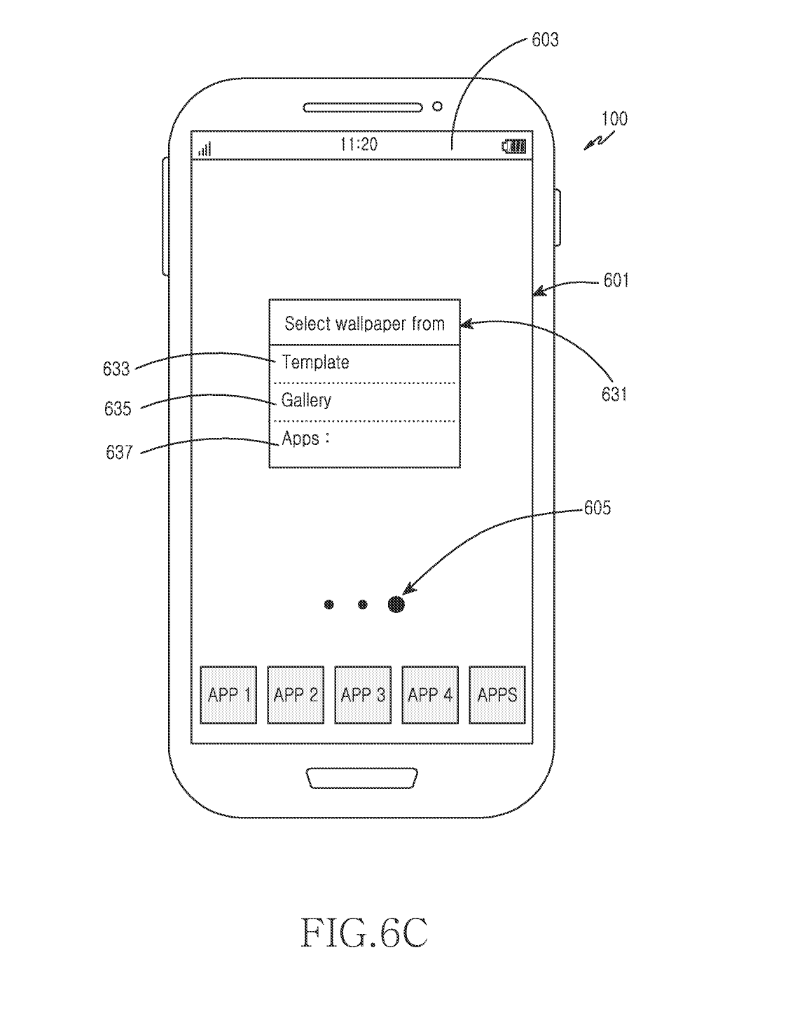

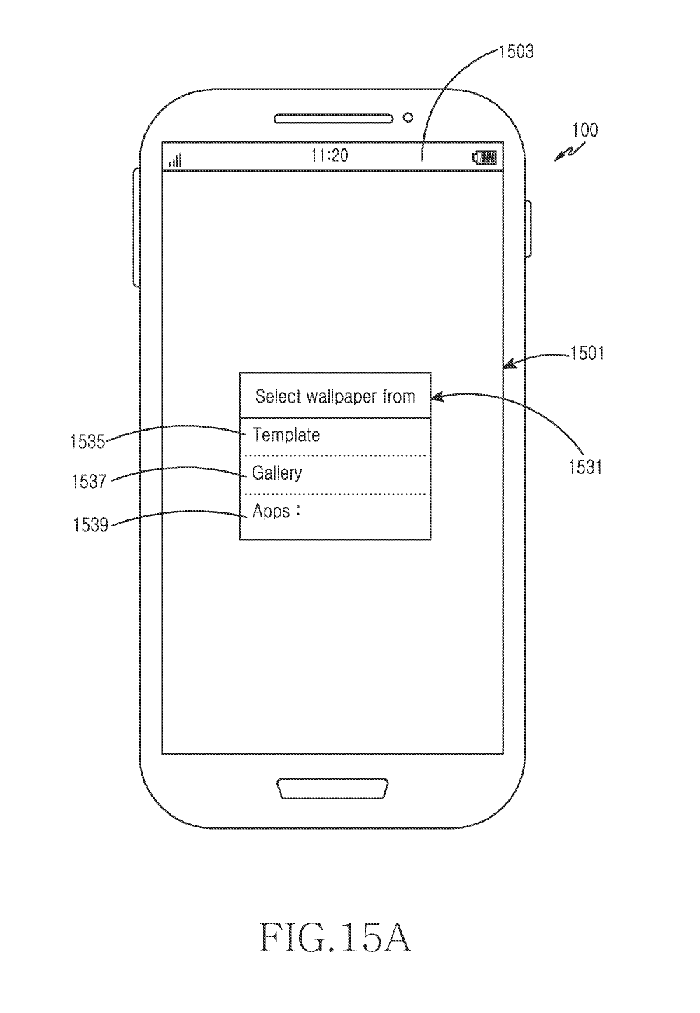

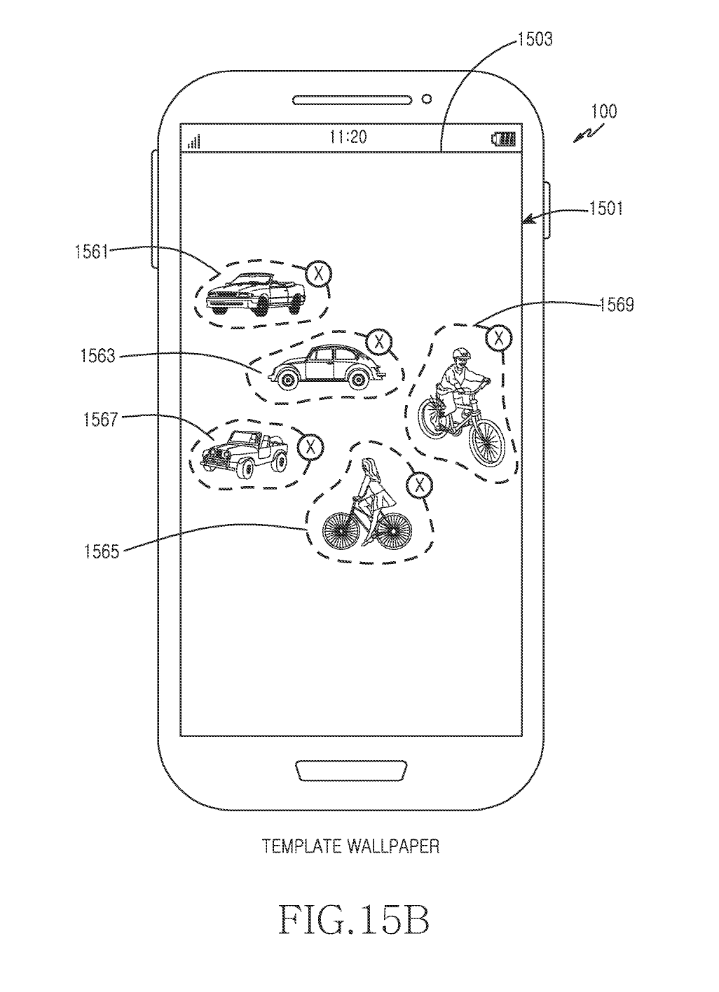

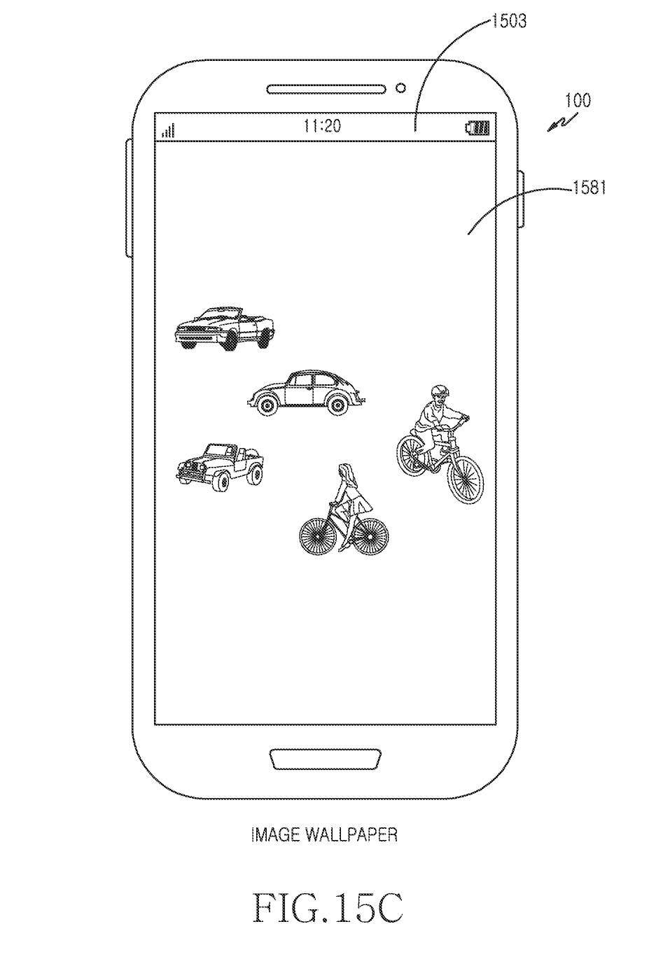

FIGS. 6A, 6B, and 6C are views illustrating a screen configuration for setting a wallpaper on a home screen on the basis of a gesture in an electronic device according to an embodiment of the present disclosure; and FIGS. 15A, 15B, and 15C are views illustrating a screen configuration for setting a wallpaper on a home screen in an electronic device according to an embodiment of the present disclosure.

Referring to FIGS. 6A, 6B, 6C, 15A, 15B, and 15C, for another example, when a user's gesture 611 occurs on a home screen on a display unit 601 of the electronic device 100, as shown in FIG. 6A, the electronic device 100 may display a home screen creation menu, as shown in FIG. 6B. At this point, when a home screen generating item 621 is selected, the electronic device 100 recognizes that a new page is created on a home screen. That is, the electronic device 100 may recognize that a fourth page, following a third page 627 is created on a home screen. If the home screen generating event does not occur, the electronic device 100 terminates this algorithm, or, the electronic device 100 may confirm whether the home screen generating event occurs periodically.

Additionally, as shown in FIG. 6A, the home screen may also display icons 609 for a widget and an application, a status bar 603, and a dock bar 607. Also, as shown in FIG. 6B, the home screen creation menu includes a second page 625, a first page 623, and a remove icon 673.

Moreover, when the home screen generating event occurs, the electronic device 100 displays a wallpaper setting menu in operation 403. For example, when the home screen generating item 521 of the menu list 513, as shown in FIG. 5B, is selected and/or the home screen generating item 621, as shown in FIG. 6B, is selected, the electronic device 100 may display the wallpaper setting menu 531, 631, 1531 as shown in FIGS. 5C, 6C, and 15A. At this point, the electronic device 100 may include at least one application list 539, 637, and 1539 providing a template 535, 633, and 1535, a gallery 537, 635, and 1537, and a wallpaper setting on the wallpaper setting menu 531, 631, and 1531, as shown respectively in FIGS. 5C, 6C, and 15A. At this point, the electronic device 100 may display the background setting menu 531 or 631 in an area, except for the dock bar 507 and page display area 505 or 605, as shown in FIGS. 5C or 6C. Here, an application providing a background setting may be an application providing display data, for example, an image viewer, a document viewer, a web viewer, and a video viewer.

Then, the electronic device 100 confirms whether a wallpaper is determined through the wallpaper setting menu in operation 405. The electronic device 100 may confirm whether at the least one application list 539, 637, and 1539 providing the template 535, 633, and 1535, a gallery 537, 635, and 1537, and/or a wallpaper setting is selected from the wallpaper setting menu 531, 631, and 1531, as shown in FIGS. 5C, 6C, and 15A.

For example, when the template 535 is selected, the electronic device 100 may display a template list 541 including at least one template as shown in FIG. 5D. When a template 545 is selected from the template list 541, the electronic device 100 may display a preview 547 of the template 545. Then, the electronic device 100 may determine a template 543 determined (565) from the template list 541 to be a wallpaper 551. Additionally, after selecting the template 545, the electronic device 100 may display a confirm menu 553 to confirm whether to determine the template 545 to be the wallpaper 551, as shown in FIG. 5E. When “confirm” icon 555 is selected from the confirm menu 553, the electronic device 100 may determine the template 545 to be the wallpaper 551.

For another example, when the gallery 537 is selected, the electronic device 100 may execute an application of a gallery 561 including a plurality of images, as shown in FIG. 5G. When an image 563 is selected from the gallery 561 and an area 565, for setting the wallpaper, is selected, the electronic device 100 may display a confirm menu 573 to confirm whether to determine the image 563 to be a wallpaper 571, as shown in FIG. 5H. When a “confirm” icon 575 is selected from the confirm menu 573, the electronic device 100 may determine the image 563 to be the wallpaper 571.

For another example, when the at least one application 539 as shown in FIG. 5C, providing a wallpaper setting is selected, the electronic device 100 may determine a content selected by a user from at least one image, document, web page, and video in a corresponding application to be a wallpaper.

If the wallpaper is not determined, the electronic device 100 maintains the display of the wallpaper setting menu in operation 403, or, the electronic device 100 may maintain the display of the wallpaper setting menu for a reference time and may release the display of the wallpaper setting menu after the reference time.

Moreover, if the wallpaper is determined, the electronic device 100 generates a home screen in operation 407. For example, when a template is set as a wallpaper, the electronic device 100 may generate a home screen including the template as shown in FIG. 5F or 15B. At this point, the template may display the area 565, and areas 567, 591, 592, 593, and 569, as shown in FIG. 5F, or areas 1561, 1563, 1565, 1567, and 1569, as shown in FIG. 15B.

For another example, when an image is selected as a wallpaper through a gallery, the electronic device 100 may generate a home screen 581, 1581 including the selected image, as shown respectively in FIG. 5I or 15C. At this point, the electronic device 100 may generate a home screen in an area except for the dock bar 507 and page display area 505-1, as shown in FIG. 5F or 5I.

Then, the electronic device 100 terminates the algorithm illustrated in FIG. 4. Also, as shown in FIG. 15, the electronic device 100 may include a display unit 1501 and may display a status bar 1503.

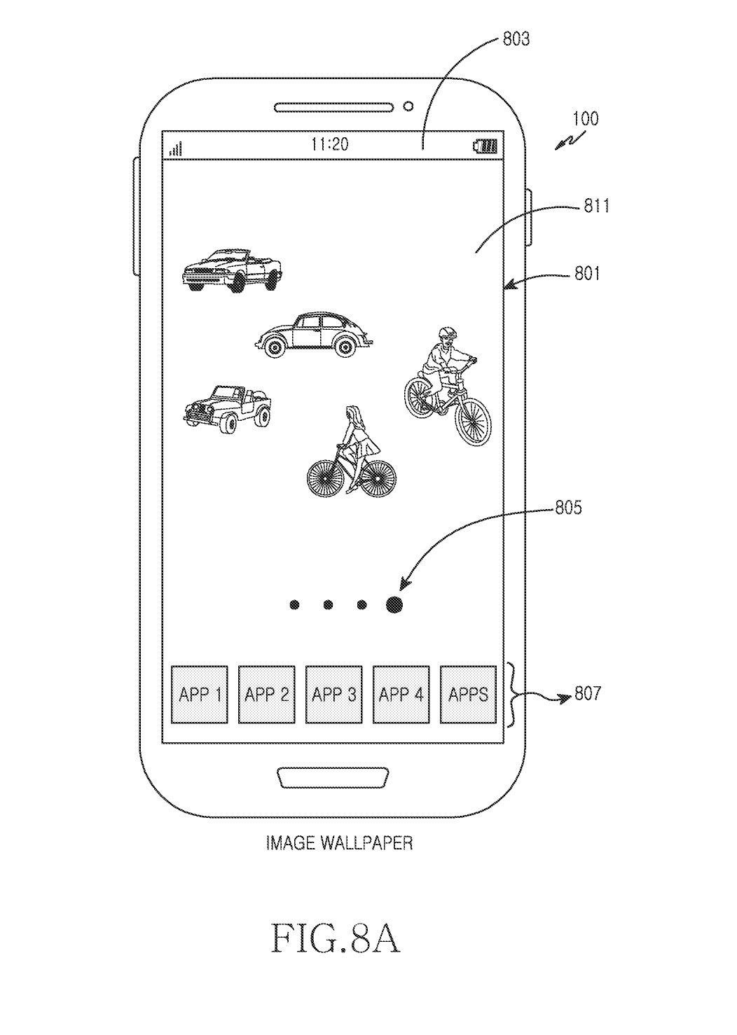

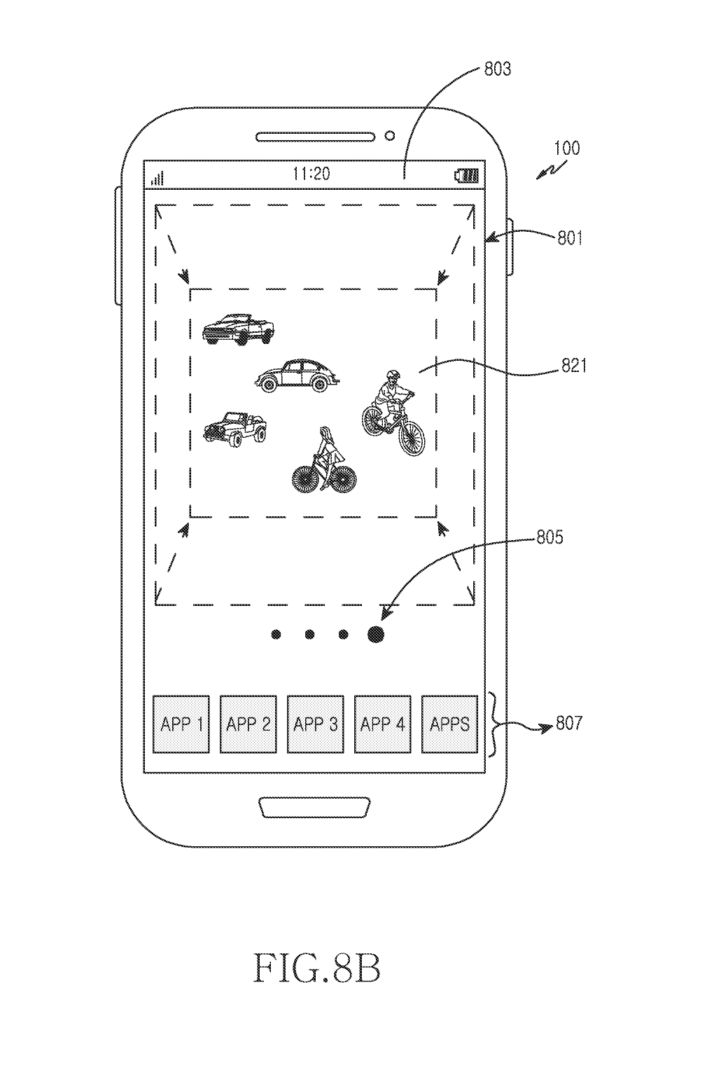

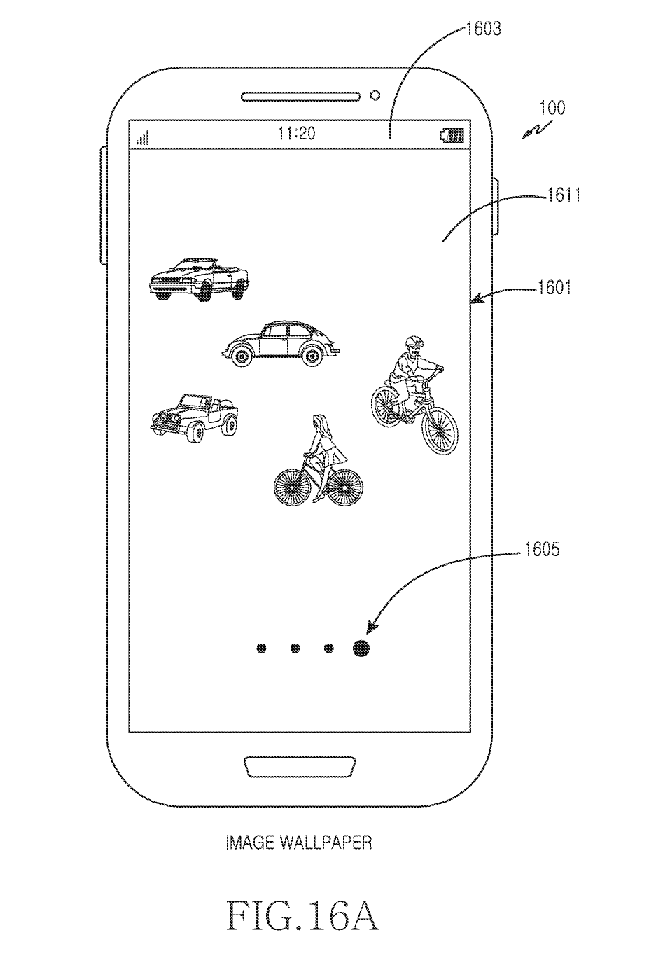

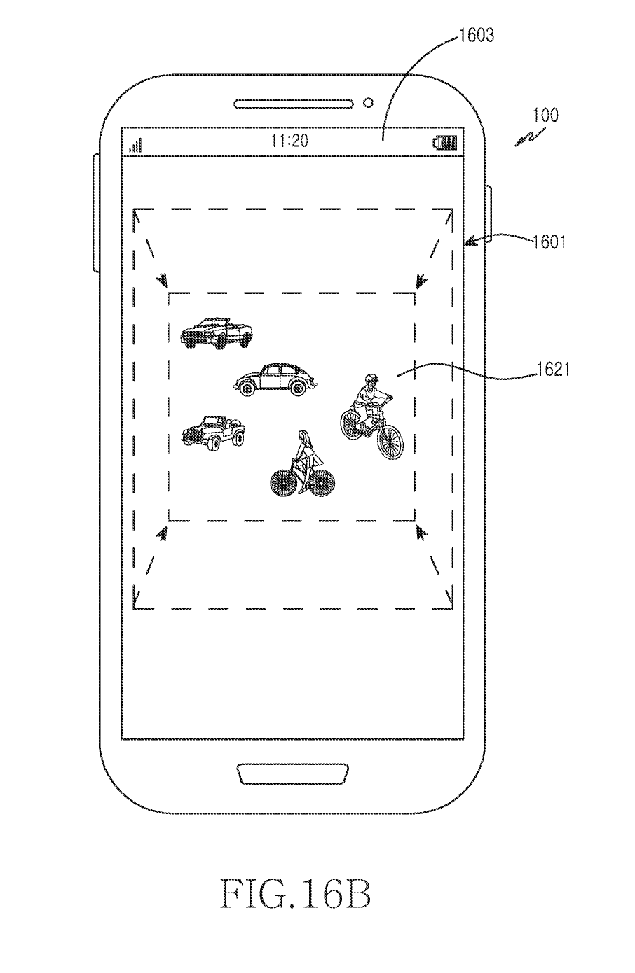

FIGS. 8A and 8B are views illustrating a screen configuration for determining the overall size of a wallpaper set on a home screen in an electronic device according to an embodiment of the present disclosure; and FIGS. 16A and 16B are views illustrating a screen configuration for determining the overall size of a wallpaper set on a home screen in an electronic device according to an embodiment of the present disclosure.

Additionally, as shown in FIG. 8A or 16A, when an image 811, 1611 is determined to be a wallpaper, the electronic device 100 may adjust the size of the image 811, 1611 as a whole, as indicated by area 821 or area 1621, as respectively shown in FIGS. 8B and 16B. Additionally, as shown in FIG. 8A, the electronic device 100 may include a display unit 801 that displays a status bar 803. Also, as shown in FIG. 16A, the electronic device 100 may include a display unit 1601 and may display a wallpaper 1611, a status bar 1603, and a page display area 1605.

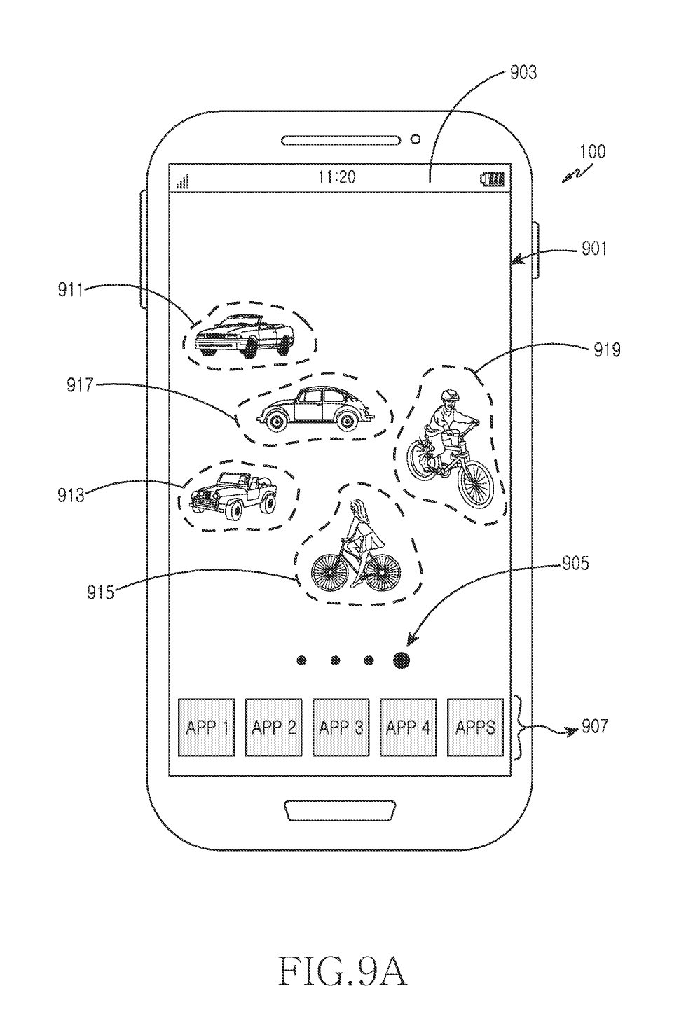

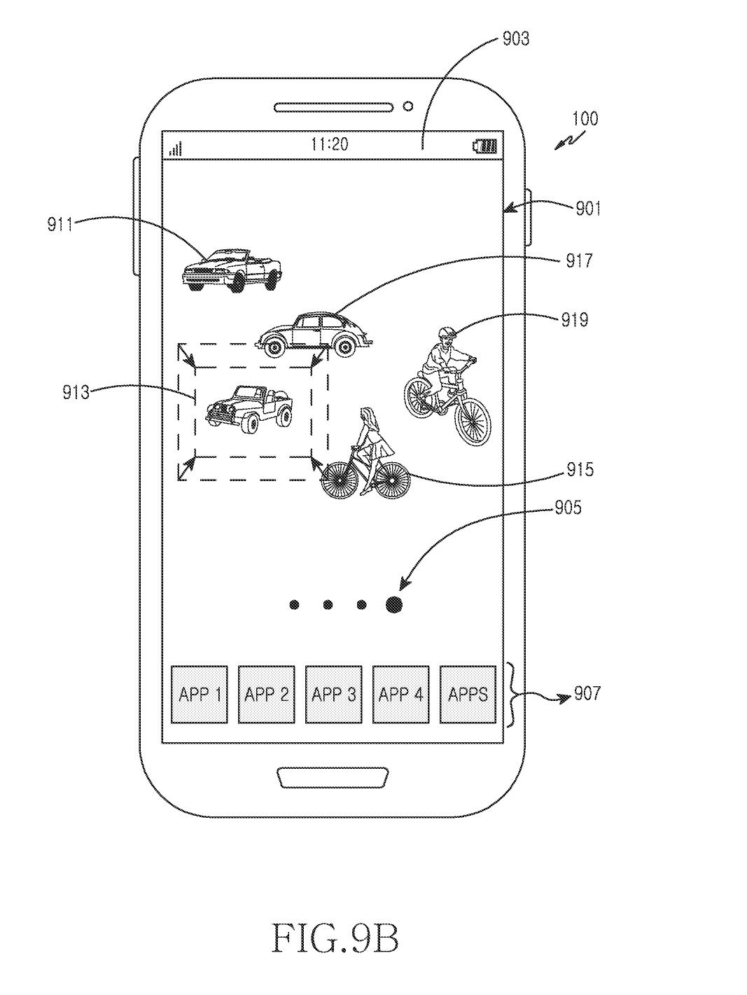

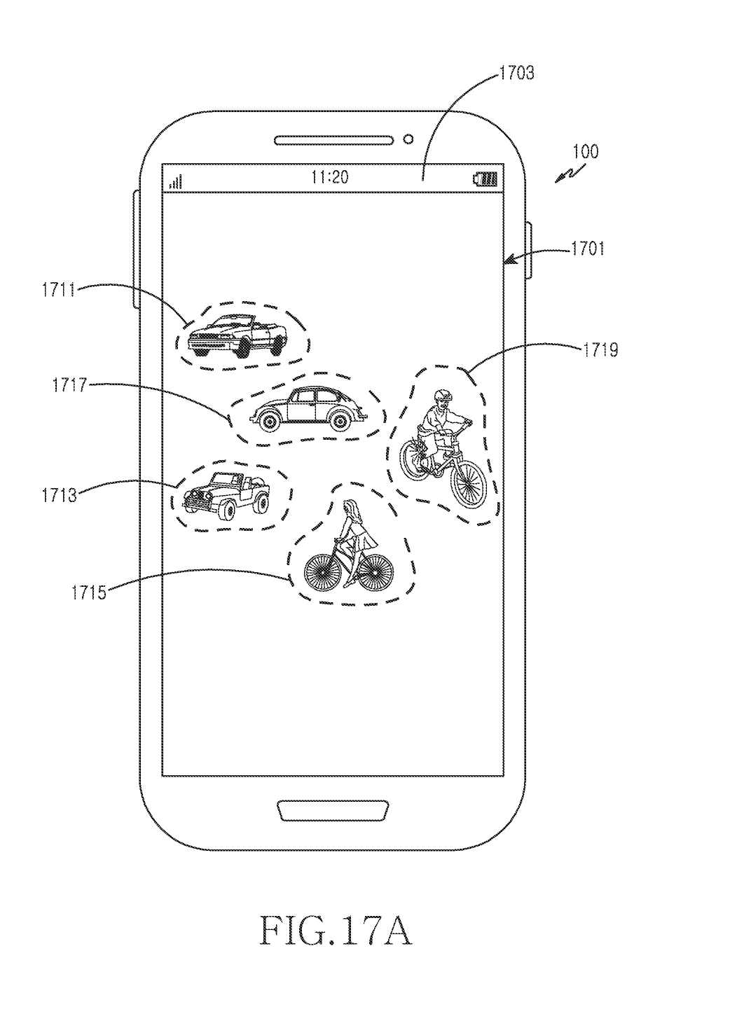

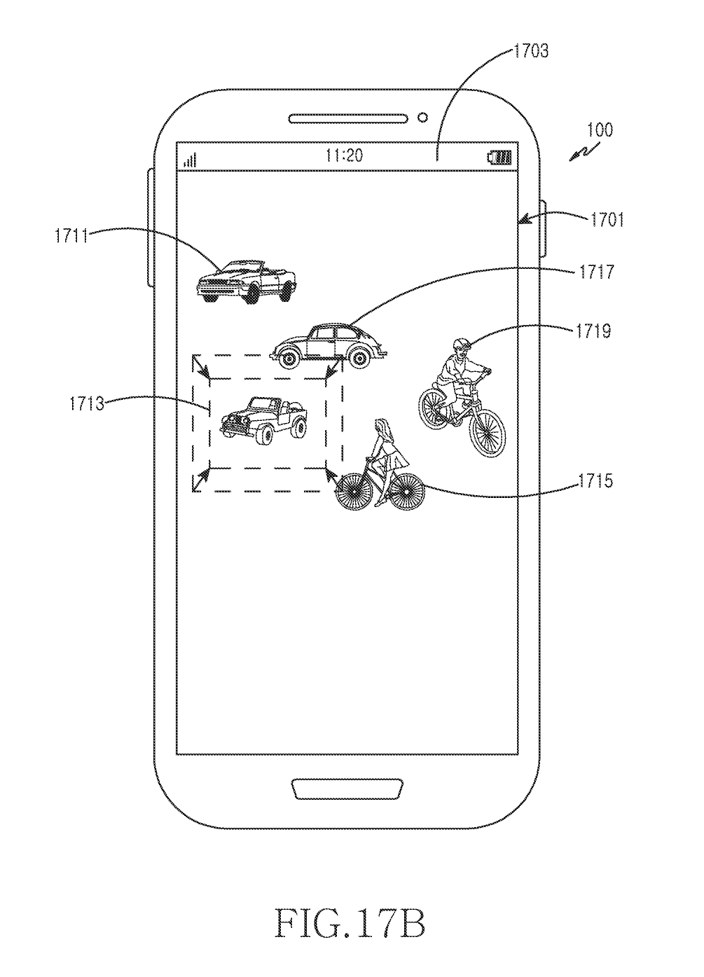

FIGS. 9A and 9B are views illustrating a screen configuration for determining the size of a partial area in a wallpaper set on a home screen in an electronic device according to an embodiment of the present disclosure; and FIGS. 17A and 17B are views illustrating a screen configuration for determining the size of a partial area in a wallpaper set on a home screen in an electronic device according to an embodiment of the present disclosure.

Additionally, as shown in FIG. 9A or 17A, when a template is determined to be a wallpaper, the electronic device may adjust the size of at least one of area 913 and/or area 1713 as respectively shown in FIGS. 9B and 17B. At this point, the electronic device may display an indicator for adjusting the size of an image or the size of an area. Additionally, the electronic device may adjust the size of an area, except for the dock bar 807, 907 and page display area 805, 905, and/or the size of an area in a template, as shown in FIGS. 8A, 8B, 9A, and 9B. Additionally, as shown in FIG. 9A, the electronic device 100 may include a display unit 901 that displays a status bar 903 and areas 911, 915, 917, and 919. Also, as shown in FIG. 17A, the electronic device 100 may include a display unit 1701 and may display a status bar 1703 and areas 1711, 1715, 1717, and 1719.

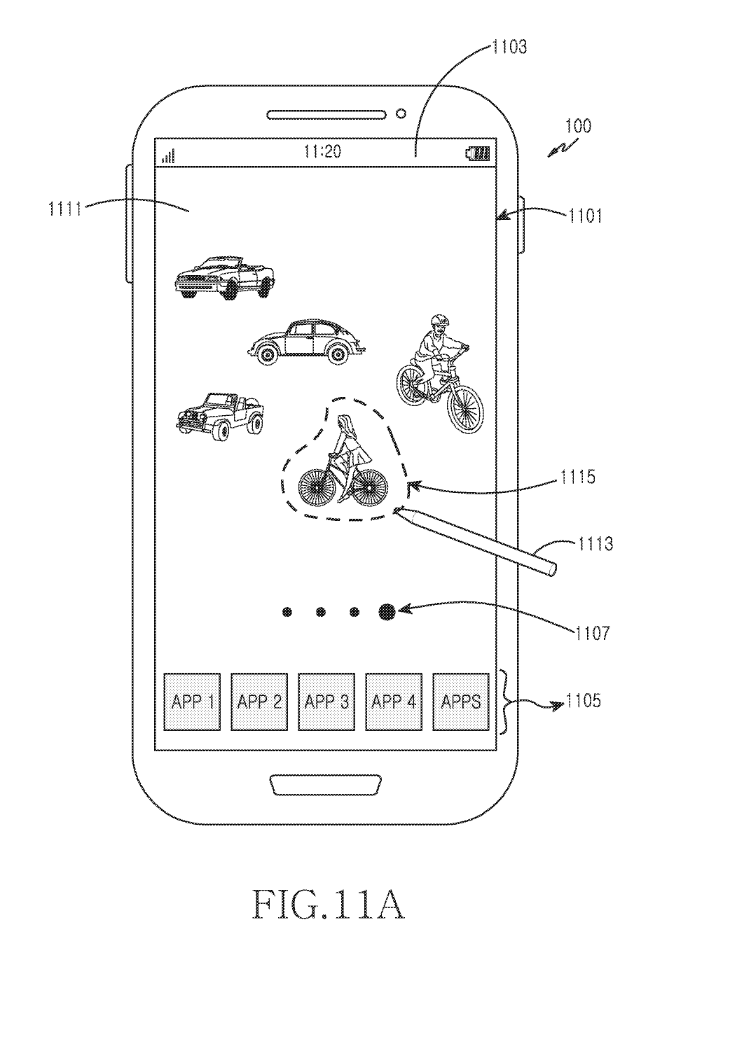

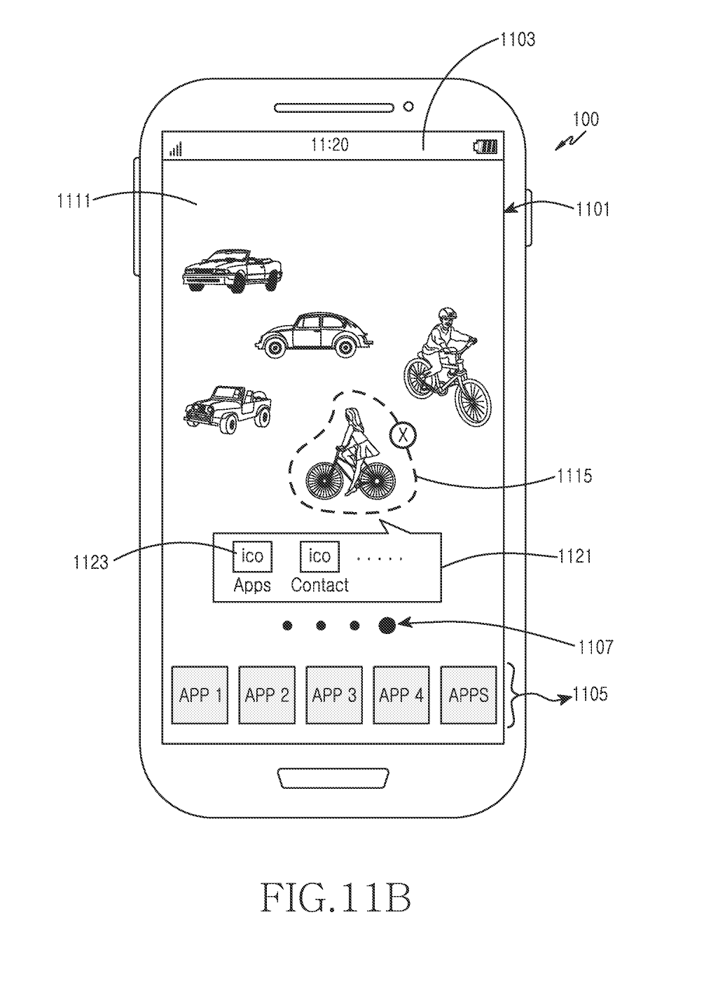

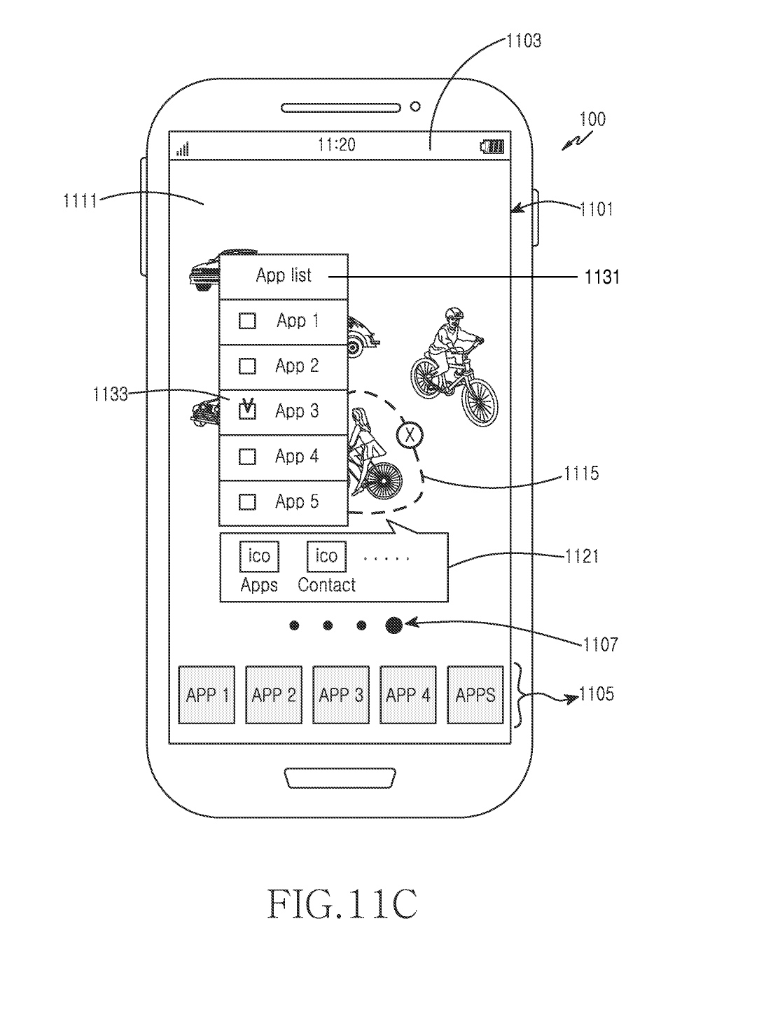

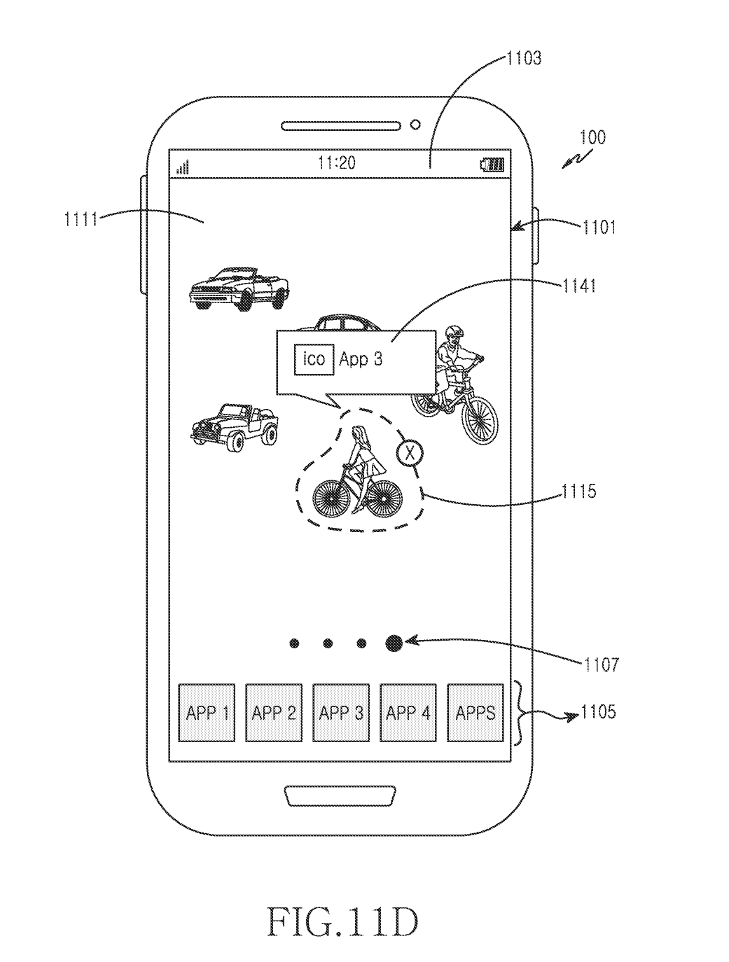

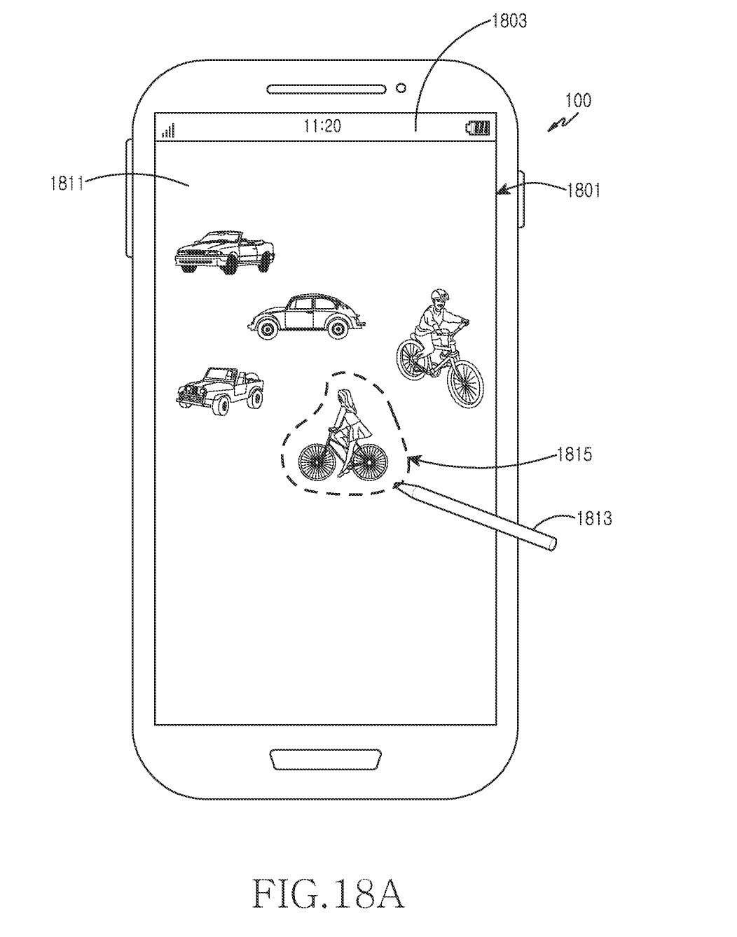

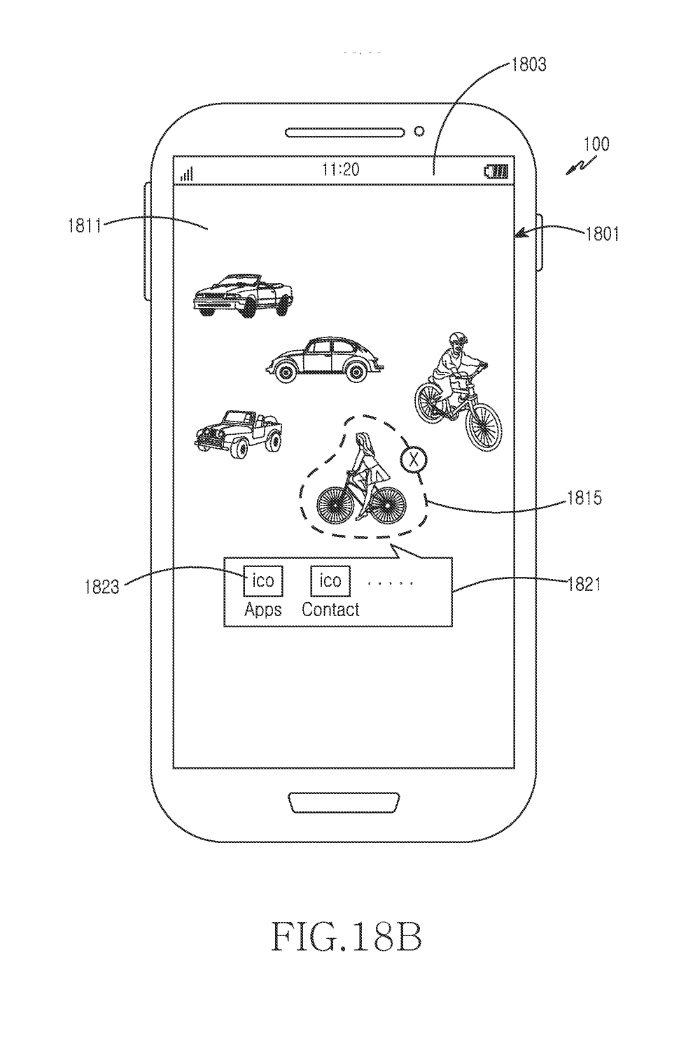

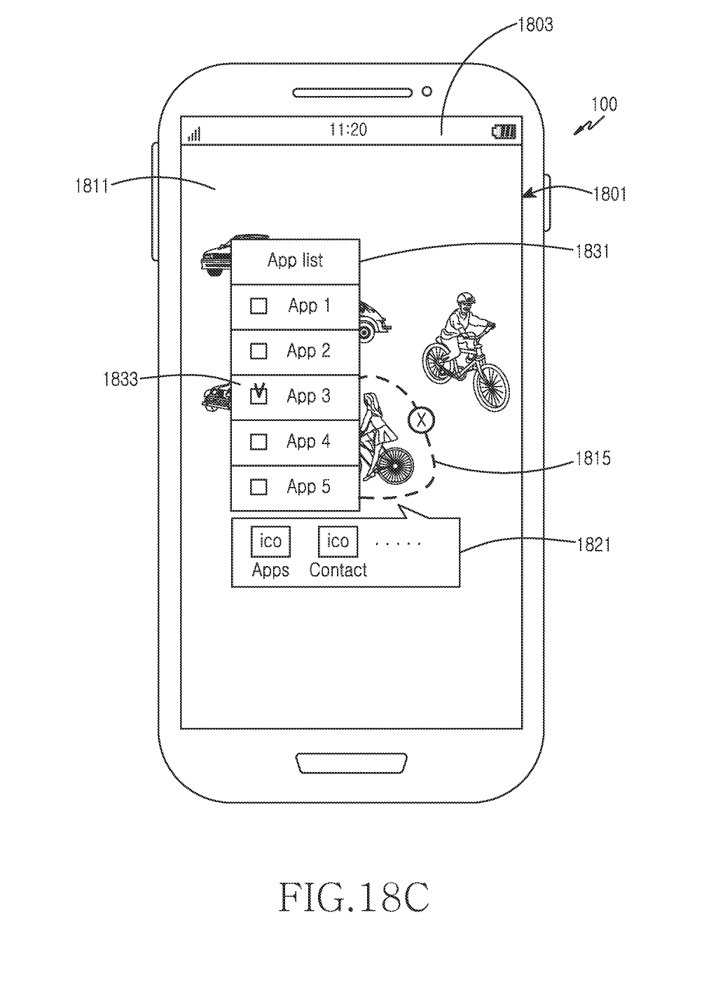

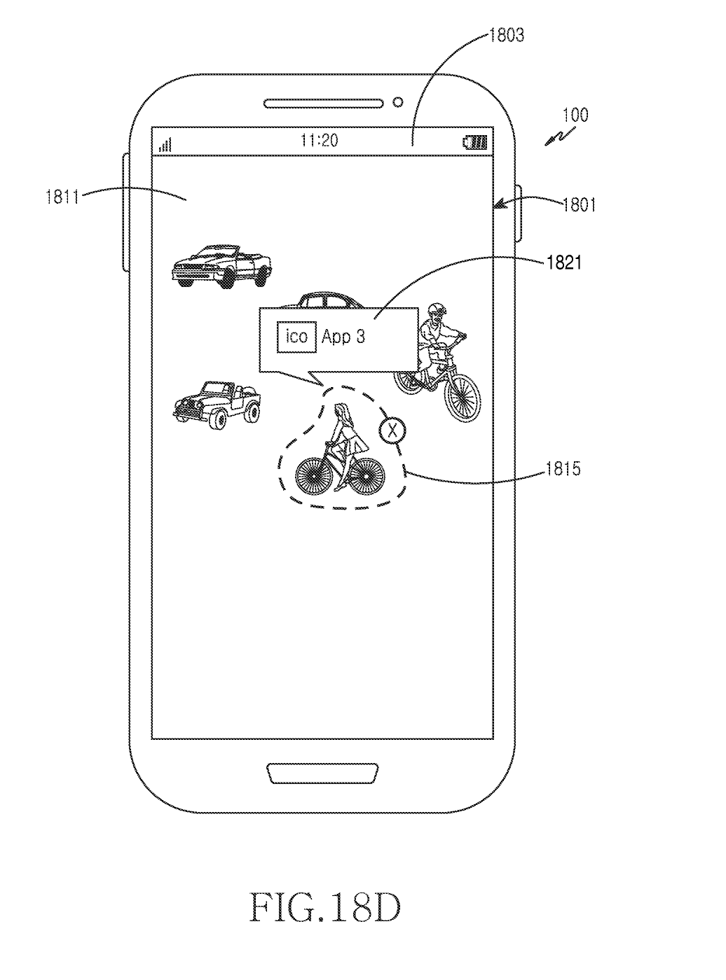

FIG. 10A is a flowchart illustrating a procedure for configuring a home screen after an electronic device determines a template as a wallpaper according to an embodiment of the present disclosure; FIG. 10B is a flowchart illustrating a procedure for configuring a home screen after an electronic device determines an image as a wallpaper according to an embodiment of the present disclosure; and FIGS. 11A, 11B, 11C, and 11D are views illustrating a screen configuration for configuring a home screen in an electronic device according to an embodiment of the present disclosure; and FIGS. 18A, 18B, 18C, and 18D are views illustrating a screen configuration for configuring a home screen in an electronic device according to an embodiment of the present disclosure.

Referring to FIG. 10A, the electronic device 100 confirms whether a template is set as a wallpaper in operation 1001. If the template is not set as the wallpaper, the electronic device 100 proceeds to operation 1017 and sets an image as a wallpaper, as shown in FIG. 10B. This will be described according to an embodiment of the present disclosure.

Moreover, when a template is set as a wallpaper, the electronic device 100 displays a predefined area in the template in operation 1003. For example, when a template is set as a wallpaper, the electronic device may display the areas 565, 567, and 569 and/or 1561, 1563, 1565, 1567, and 1569 included in the template as respectively shown in FIGS. 5F and 15B. At this point, the electronic device 100 may display an icon for releasing the selection of each area. Additionally, the electronic device 100 may change the size of each area. Additionally, the electronic device 100 may move each area. At this point, the electronic device 100 may display predefined areas included in the template in an area except for the dock bar 507 and page display area 505-1 as shown in FIG. 5F.

Then, the electronic device 100 determines which area is selected in operation 1005. For example, the electronic device 100 may confirm which area is selected from among the areas 565, 567, and 569 and/or 1561, 1563, 1565, 1567, and 1569 included in the template as respectively shown in FIG. 5F and 15B. If an area is not selected, the electronic device 100 proceeds to operation 1013 and determines whether the home screen generating event is terminated. Additionally, when an area is not selected, the electronic device 100 may continuously perform determining which area is selected. Moreover, when an area is not selected, the electronic device 100 determines which area is selected for, and/or during, a reference time and when an area is not selected for, and/or during, the reference time, the electronic device 100 may confirm whether the home screen generating event is terminated.

Moreover, when area is selected, the electronic device 100 displays an item, and/or content, linkable to the selected area in operation 1007. For example, when the area 565 or the area 1565 is respectively selected from among the areas 565, 567, 591, 592, 593, and 569 or the areas 1561, 1563, 1565, 1567, and 1569, as respectively shown in FIG. 5F and 15B, the electronic device 100 may display content linkable to a first area 1115 or a first area 1815, as respectively indicated by icon 1121 or icon 1821, as respectively shown in FIGS. 11B and 18B. Here, the linkable content may include at least one application, at least one contact, and at least one bookmark.

The electronic device 100 determines whether an item, and/or content, is selected for linking to an area in operation 1009. For example, the electronic device 100 may confirm which content is selected from contents linkable to the first area 1115 and/or the first area 1815, as respectively shown in FIGS. 11B and 18B.

If content is not selected, the electronic device proceeds to operation 1013 and determines whether the home screen generating event is terminated.

Moreover, if the electronic device 100 determines that the item, and/or content, is selected in operation 1009, the electronic device links the item, and/or content, to an area in operation 1011. For example, when an application 1123 or an application 1833 is selected from contents linkable to the first area 1115 or the first area 1815, as respectively shown in FIGS. 11B and 18B, the electronic device 100 may respectively display an application list 1131 and an application list 1831 as respectively shown in FIGS. 11C and 18C. If “App3” 1133 and/or “App3” 1833 is selected, the electronic device 100 respectively links the “App3” 1133 and/or the “App3” 1833 to the first area 1115 and/or the first area 1815, as respectively shown in FIGS. 11D and 18D. At this point, the electronic device 100 may display an icon and/or name (1841) of an application linked to the first area 1115 and/or the first area 1815. Additionally, the electronic device 100 may change an icon and/or name of an application linked to the first area 1115 and/or the first area 1815. Additionally, the electronic device 100 may release the display of an icon and/or name of an application linked to the first area 1115 and/or the first area 1815.

Then, the electronic device 100 determines whether to terminate the home screen generating event in operation 1013. If the home screen generating event is not terminated, the electronic device 100 proceeds to operation 1003 and maintains the display of a predetermined area in a template.

Moreover, when the home screen generating event is terminated, the electronic device 100 displays a home screen in operation 1015. Also, as shown in FIG. 11, the electronic device 100 may include a display unit 1101 and may display a wallpaper 1111, a status bar 1103, a page display area 1107, and at least one application icon 1105. Additionally, as shown in FIG. 18A, the electronic device 100 may include a display unit 1801 that displays a status bar 1803, and a wallpaper 1811.

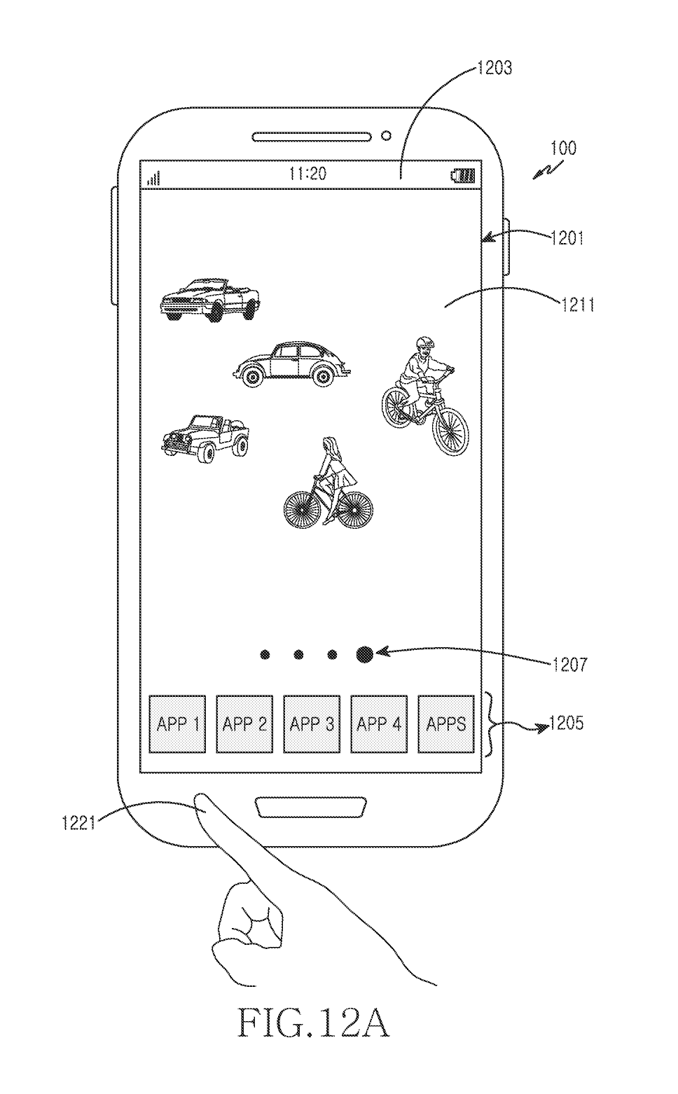

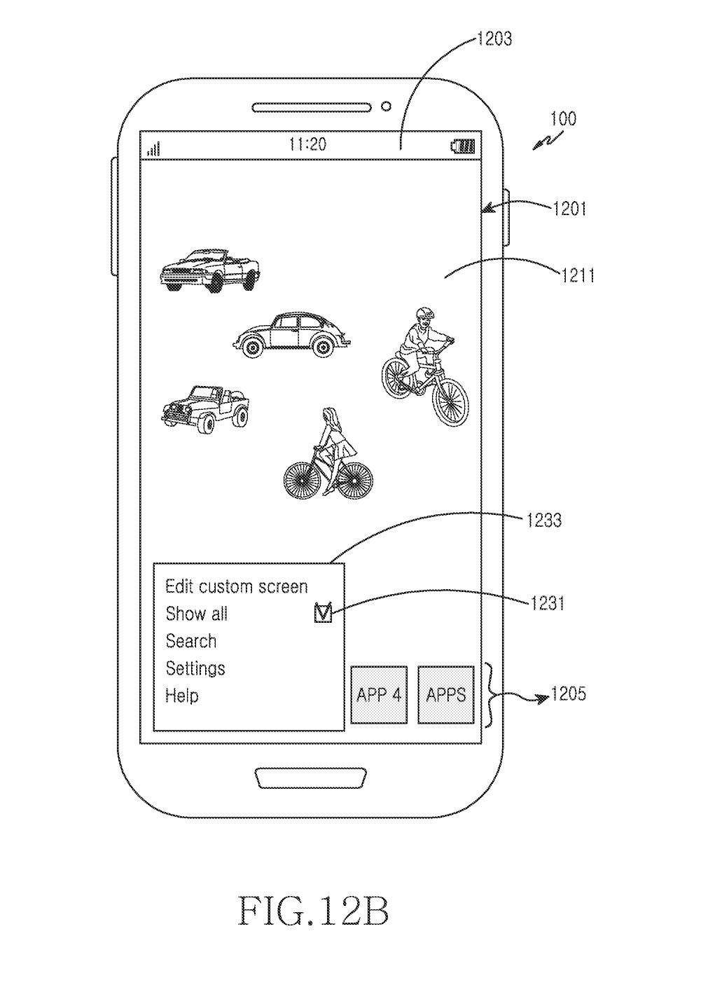

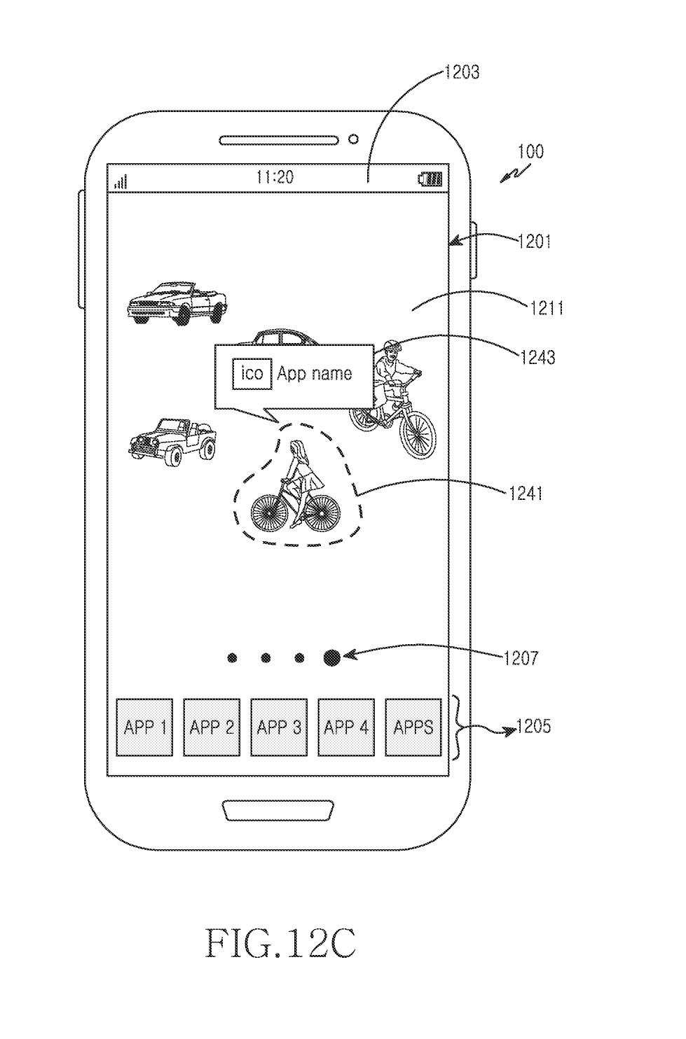

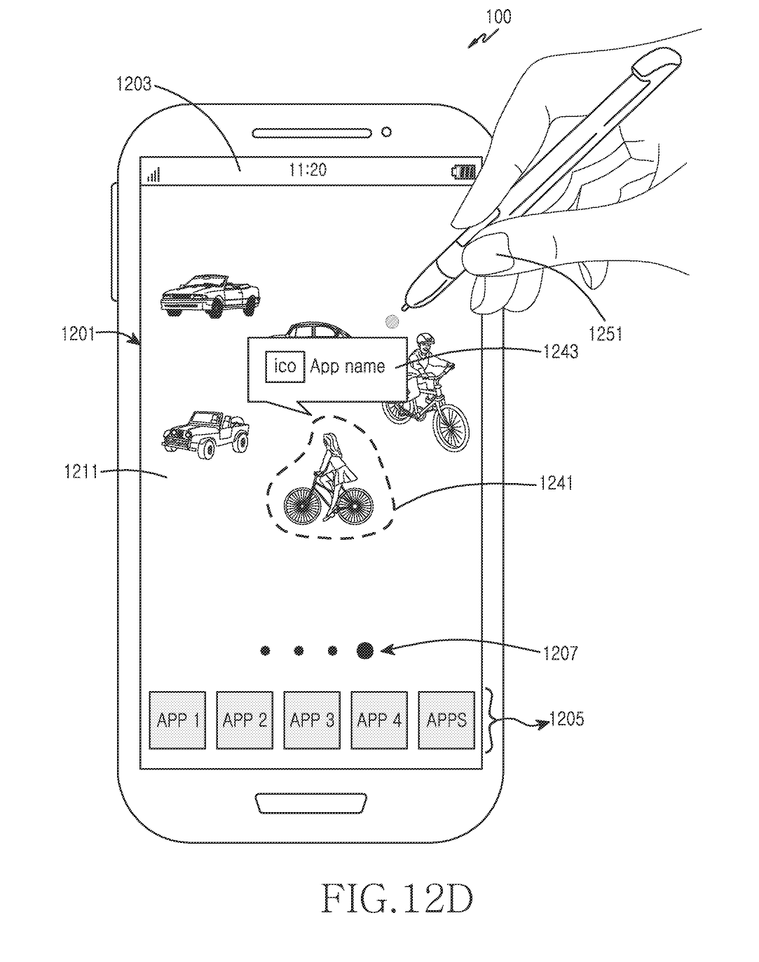

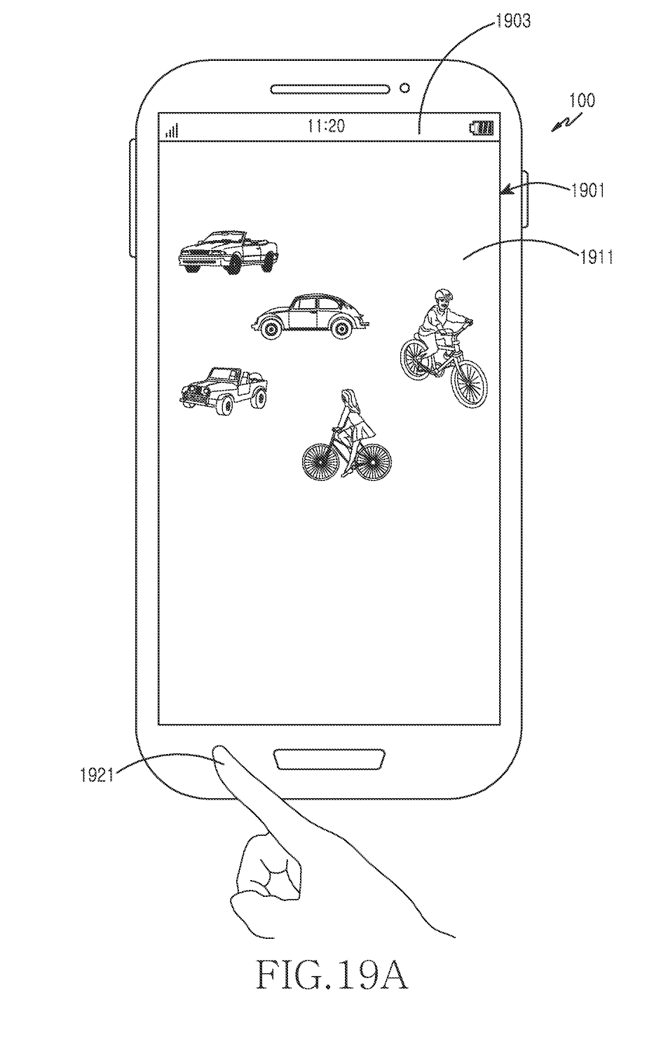

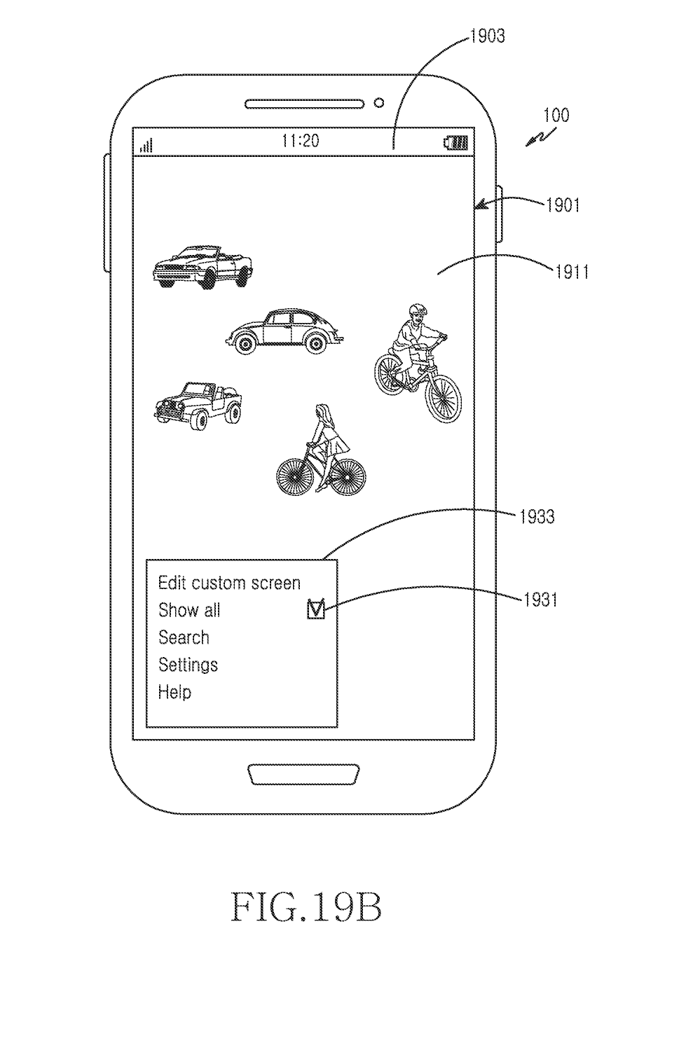

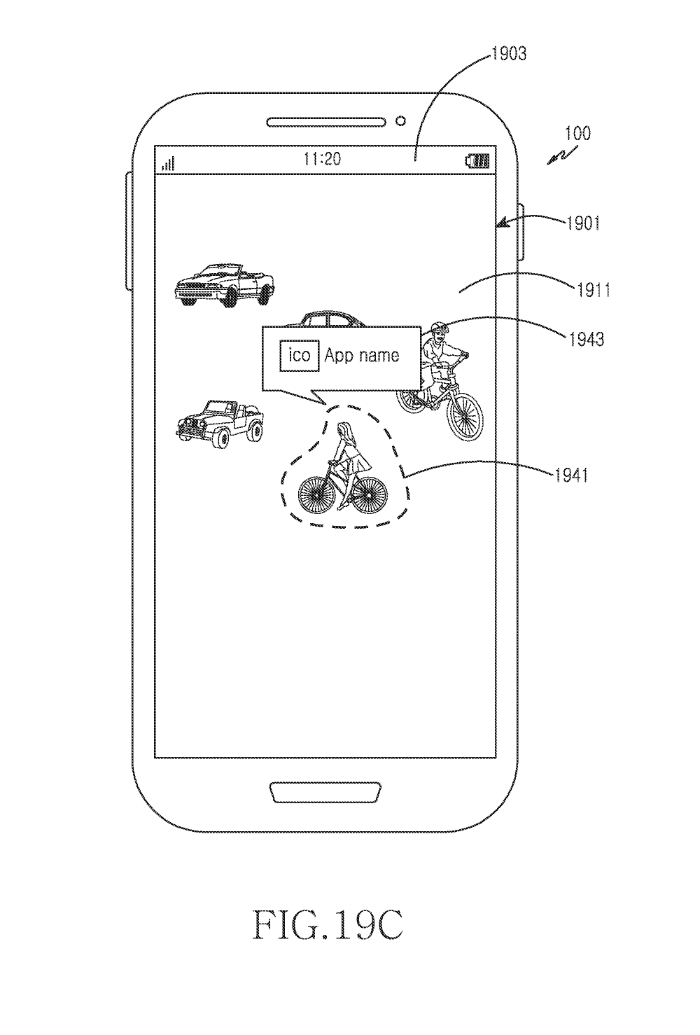

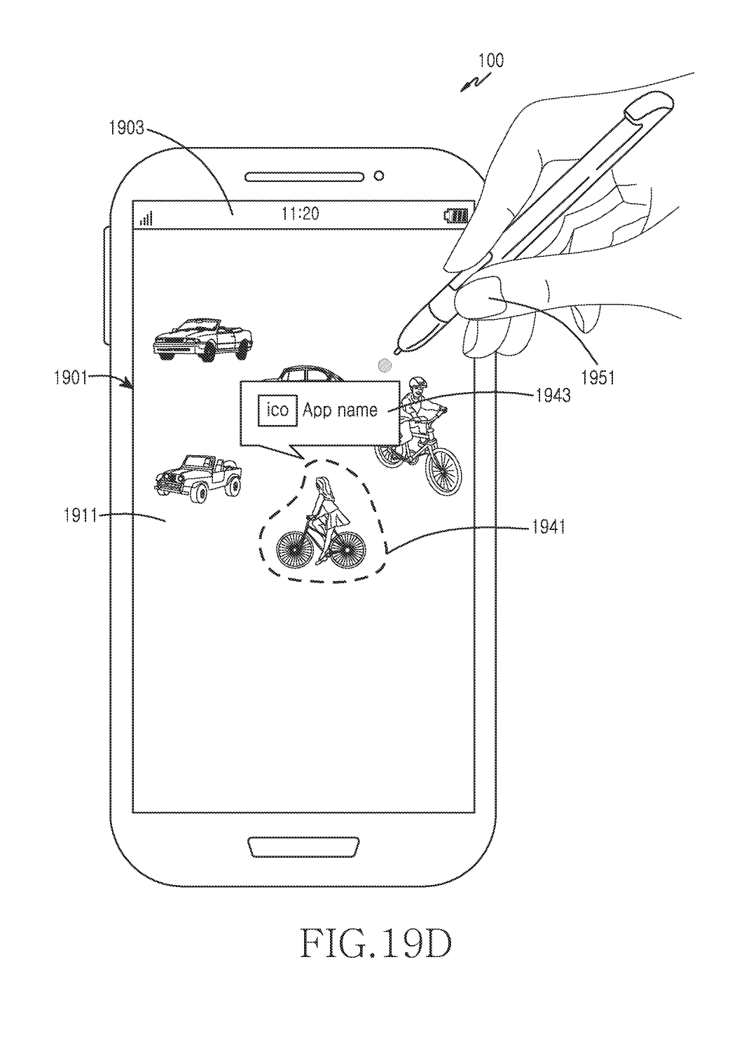

FIGS. 12A, 12B, 12C, and 12D are views illustrating a screen configuration when a configuration of a home screen is completed in an electronic device according to an embodiment of the present disclosure; and FIGS. 19A, 19B, 19C, and 19D are views illustrating a screen configuration when a configuration of a home screen is completed in an electronic device according to an embodiment of the present disclosure.

For example, the electronic device 100 may display a home screen as shown in FIGS. 12A and 19A. When a menu button 1221 and/or a menu button 1921 is selected by a user, the electronic device 100 may display a menu list 1231 and/or a menu list 1931 in a pop-up window, as respectively shown in FIGS. 12B and 19B. When an area view 1233 and/or an area view 1933 is selected from the menu list 1231 and/or the menu list 1931, the electronic device 100 may display an area 1241 or an area 1941 including a link from among areas included in the home screen, as respectively shown in FIGS. 12C and 19C.

For another example, after the home screen is displayed, as shown in FIGS. 12A and 19A, when a specific operation, for example, a hovering operation, using an electronic pen 1251 or an electronic pen 1951, occurs as respectively shown in FIGS. 12D and 19D, the electronic device 100 may display an area 1243 and/or an area 1943 including a link from among areas in the home screen, as respectively shown in FIGS. 12D and 19D.

For another example, as respectively shown in FIGS. 12C and 19C, the electronic device 100 may maintain the display of the area 1241 or the area 1941 including a link among areas included in the home screen.

Then, the electronic device terminates this algorithm illustrated in FIG. 10A. Additionally, the electronic device 100 may include a display unit 1201, and may display a wallpaper 1211, a status bar 1203, at least one application 1205, and a page display area 1207. Also, as illustrated in FIG. 19A, the electronic device 100 may include a display unit 1901, and may display a wallpaper 1911, and a status bar 1903.

FIG. 10B is a flowchart illustrating a procedure for configuring a home screen after an electronic device determines an image as a wallpaper according to an embodiment of the present disclosure.

Referring to FIG. 10B, when a template is not set as a wallpaper, the electronic device 100 may determine an image to be a wallpaper. Accordingly, the electronic device 100 determines whether an area is determined from a wallpaper in operation 1021. For example, the electronic device 100 may determine whether an area is selected from the home screen 581 and/or the home screen 1581 determined to be the wallpaper according to a user's selection, as respectively shown in FIG. 5I and FIG. 15C. At this point, the electronic device 100 may determine whether an area is determined based on a user's selection from an area except for the dock bar 507 and the page display area 505-1, as shown in FIG. 5I. If an area is not selected, the electronic device 100 proceeds to operation 1029 and determines whether the home screen generating event is terminated. Additionally, when an area is not determined, the electronic device 100 may continuously determine whether an area is determined. Moreover, when an area is not determined, the electronic device 100 determines which area is determined for a reference time and when an area is not terminated for the reference time, the electronic device 100 may determine whether the home screen generating event is terminated.

Moreover, when an area is determined from the wallpaper, the electronic device displays a linkable item in the area, the linkable item being linkable to the determined area, in operation 1023. When a user determines the first area 1115 and/or the first area 1185 through an electronic pen 1113 and/or an electronic pen 1813, as respectively shown in FIGS. 11A and 18A, the electronic device 100 may display content linkable to the first area 1115 and/or the first area 1815, as respectively indicated by the icon 1121 and/or the icon 1821, as respectively shown in FIGS. 11B and 18B. Here, the linkable content may include at least one application, at least one contact, and at least one bookmark.

Then, the electronic device 100 determines whether an item, or in other words, content for linking to an area, is selected in operation 1025. For example, the electronic device 100 may confirm which content is selected from among contents linkable to the first area 1115 or the first area 1815, as respectively shown in FIGS. 11B and 18B.

If content is not selected, the electronic device 100 proceeds to operation 1029 and determines whether the home screen generating event is terminated.

Moreover, if content is selected, the electronic device 100 links the item, or in other words, the selected content, to an area in operation 1027. For example, when the application 1133, which may be referred to as “App3” 1133, and/or the application 1833, which may be referred to as “App3” 1833, is selected from contents linkable to the first area 1115 and/or the first area 1815, as respectively shown in FIGS. 11B and 18B, the electronic device 100 may display an application list 1131 and/or an application list 1831, as respectively shown in FIGS. 11C and 18C. If the “App3” 1133 or the “App3” 1833 is selected, the electronic device 100 links the “App3” 1133 and/or the “App3” 1833 to the first area 1115 and/or the first area 1815, as respectively shown in FIGS. 11D and 18D. At this point, the electronic device 100 may display an icon and/or name of an application linked to the first area 1115 and/or the first area 1815. Additionally, the electronic device 100 may change an icon and/or name of an application linked to the first area 1115 and/or the first area 1815. Additionally, the electronic device 100 may release the display of an icon and/or name of an application linked to the first area 1115 and/or the first area 1815.

Then, the electronic device 100 determines whether to terminate the home screen generating event in operation 1029. If the home screen generating event is not terminated, the electronic device 100 proceeds to operation 1021 and may continuously determine whether an area is determined.

Moreover, when the home screen generating event is terminated, the electronic device 100 displays a home screen in operation 1031.

For example, the electronic device 100 may display a home screen as shown in FIG. 12A or 19A. When the menu button 1221 or the menu button 1921 is selected by a user, the electronic device 100 may display the menu list 1231 and/or the menu list 1931 in a pop-up window, as respectively shown in FIGS. 12B and 19B. When the area view 1233 and/or the area view 1933 is selected from the menu list 1231 and/or the menu list 1931, the electronic device 100 may display the area 1241 and/or the area 1941 including a link from among areas included in the home screen, as respectively shown in FIGS. 12C and 19C.

For another example, after the home screen is displayed, as shown in FIGS. 12A and 19A, when a specific operation, for example, the hovering operation, using the electronic pen 1251 and/or the electronic pen 1951 occurs, as respectively shown in FIGS. 12D and 19D, the electronic device 100 may display an area 1243 or an area 1943, including a link from among areas in the home screen, as respectively shown in FIGS. 12D and 19D.

For another example, as shown in FIGS. 12C and 19C, the electronic device 100 may maintain the display of the area 1241 and/or the area 1941 including a link among areas included in the home screen.

Then, the electronic device terminates this algorithm illustrated in FIG. 10B.

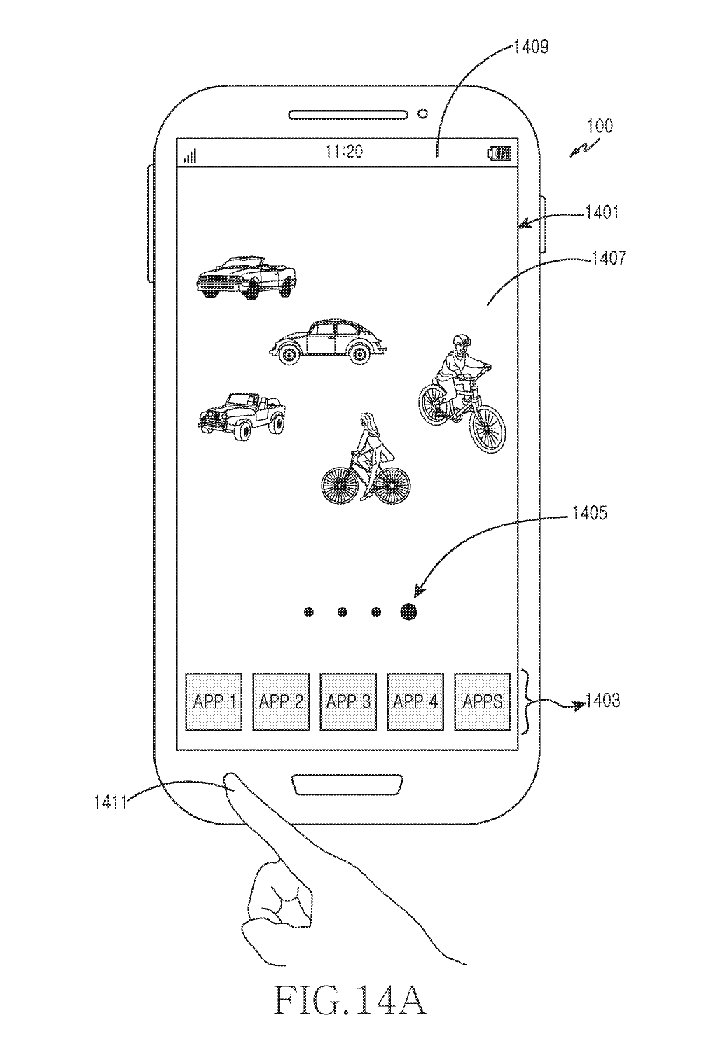

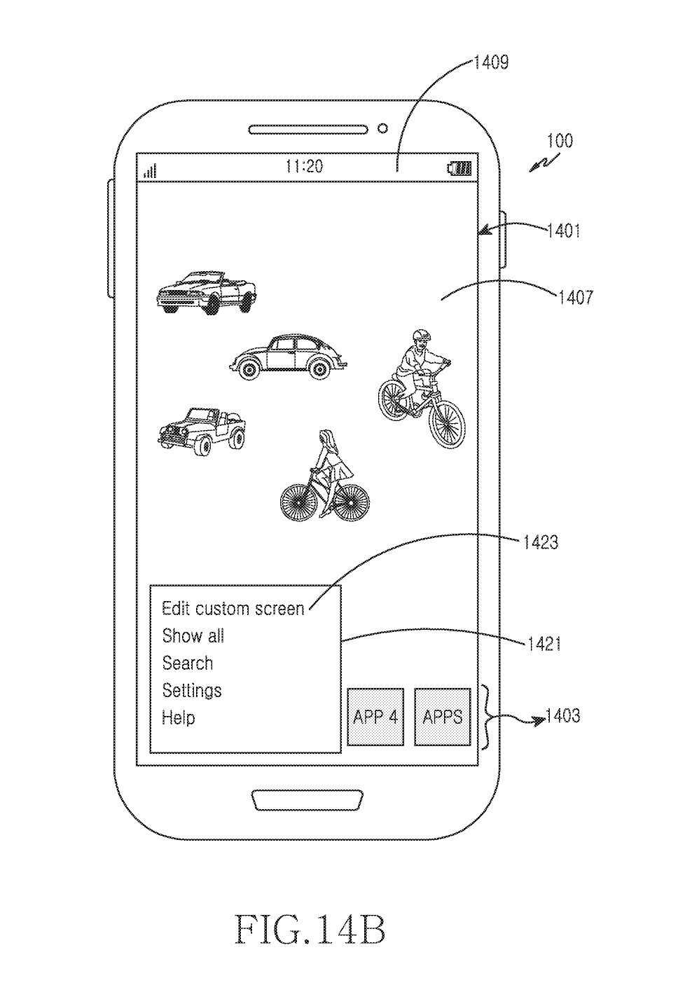

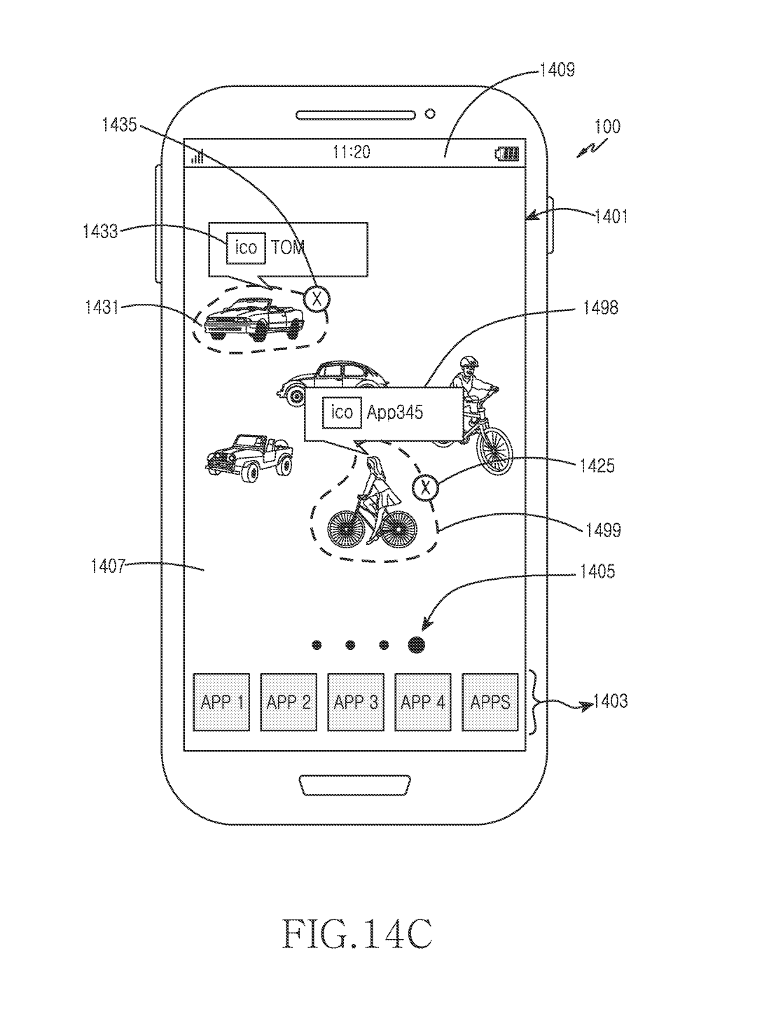

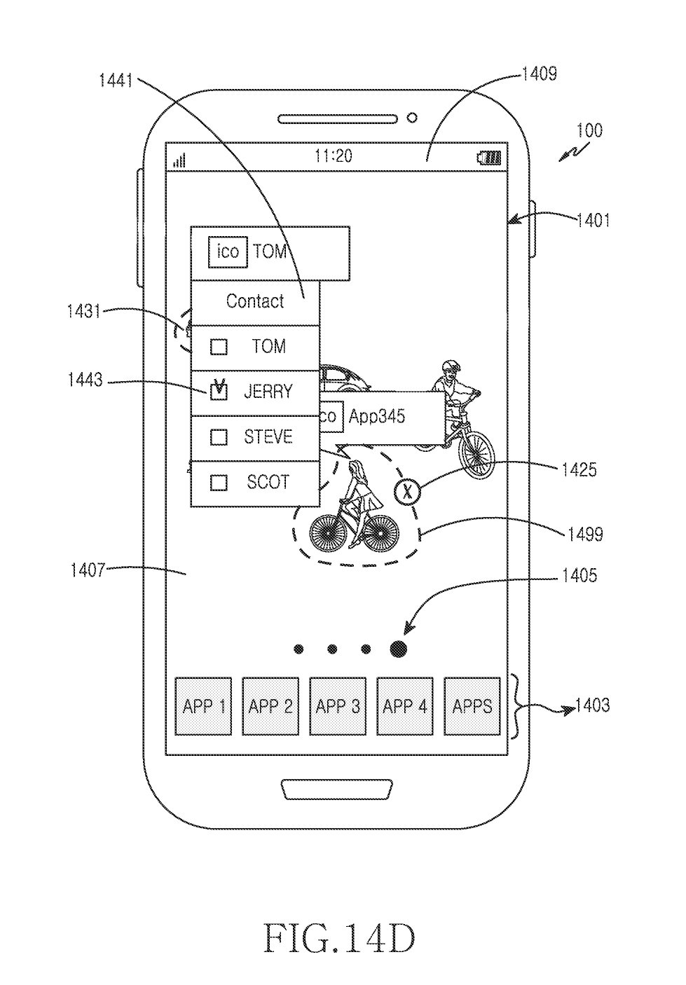

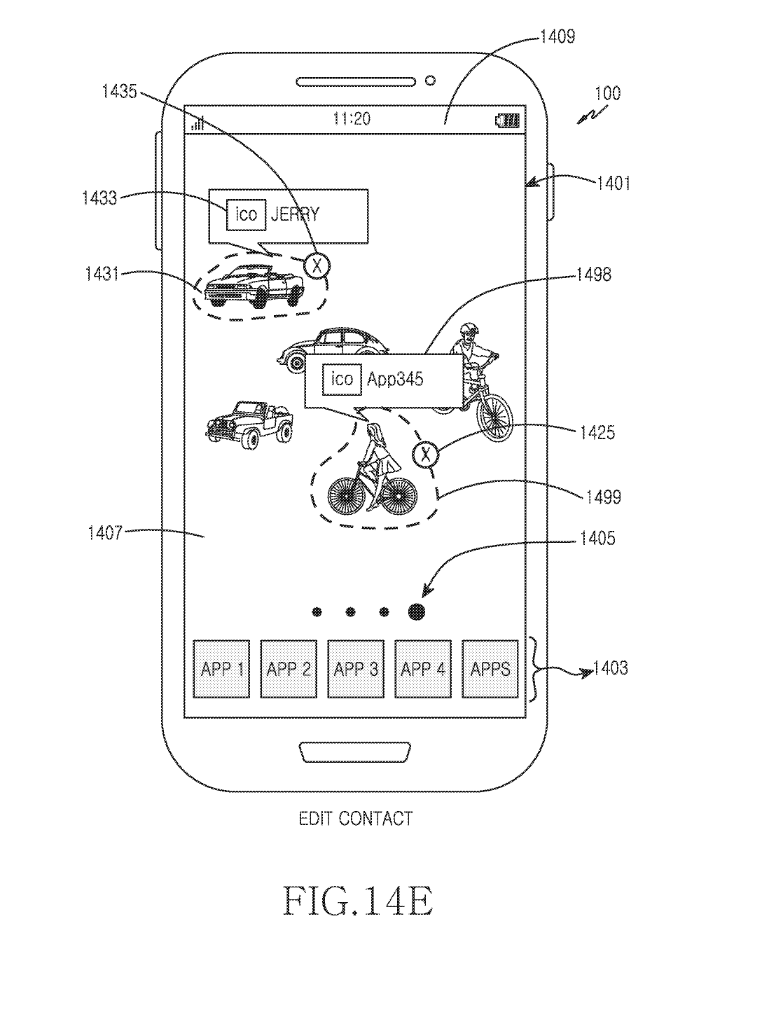

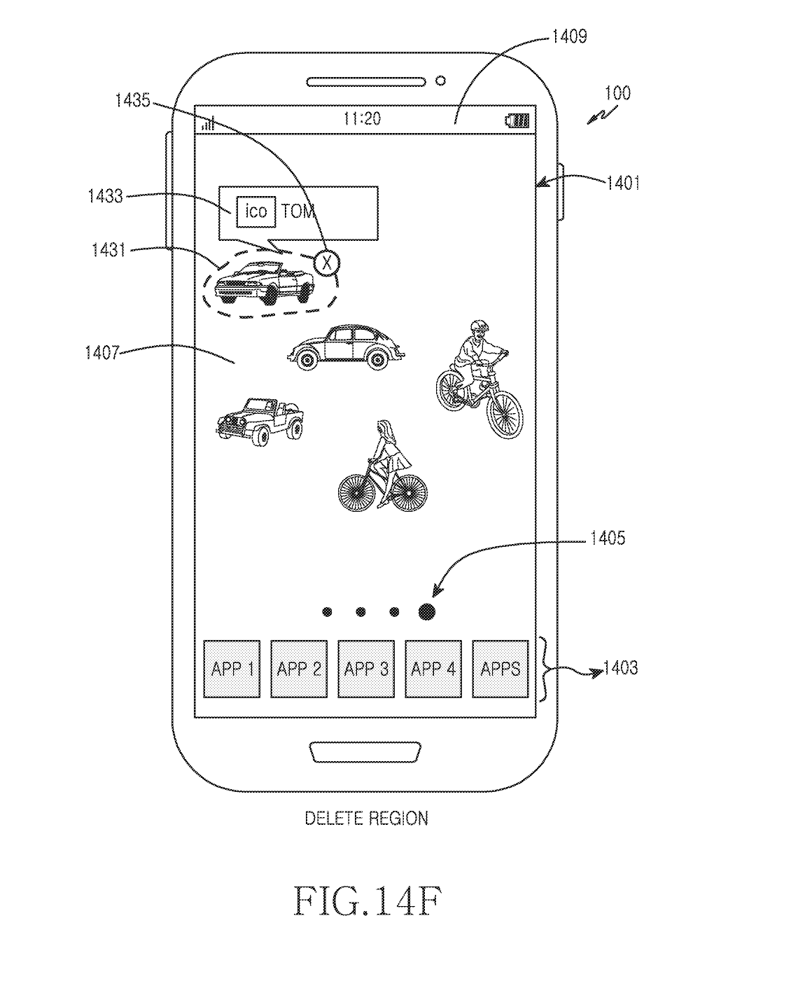

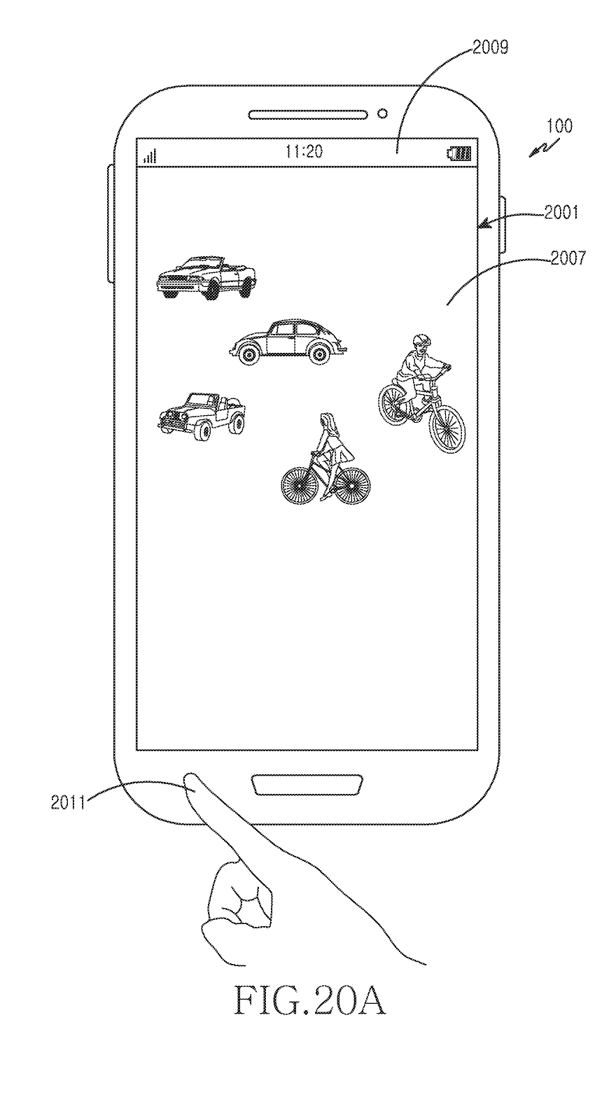

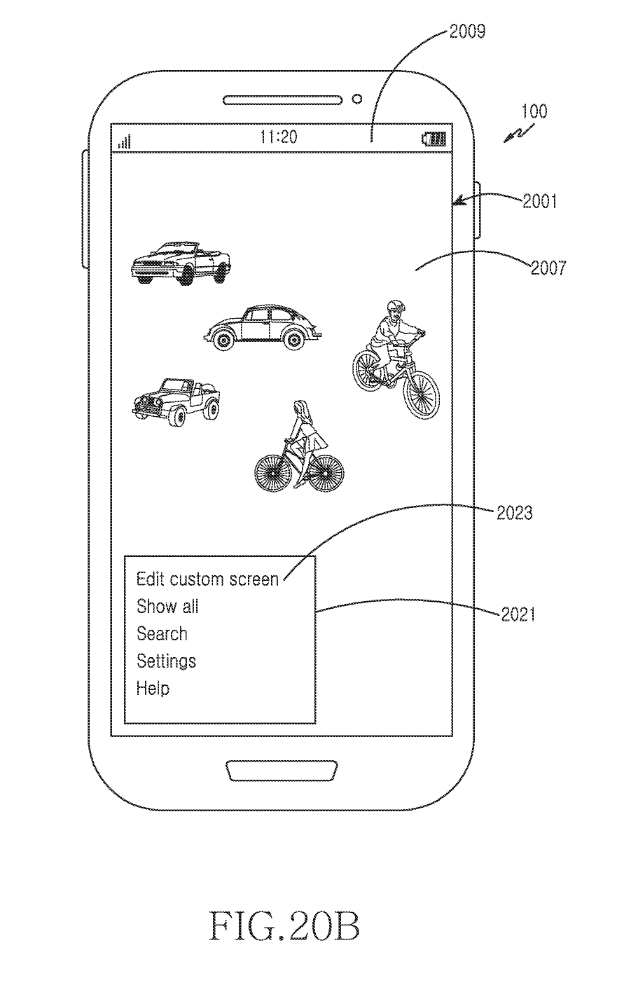

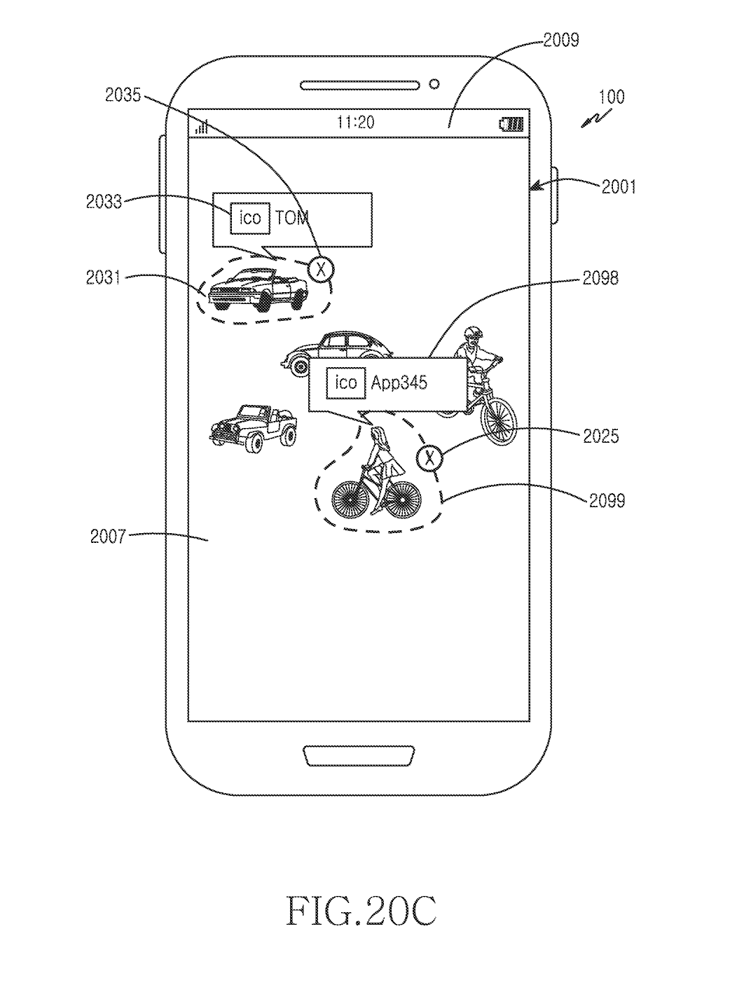

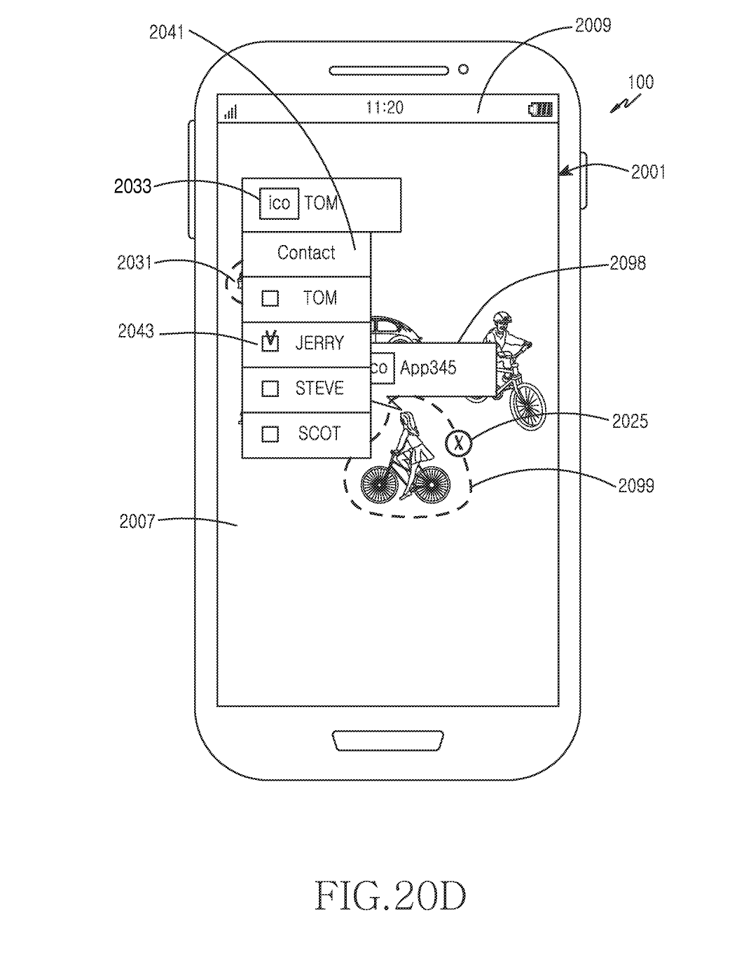

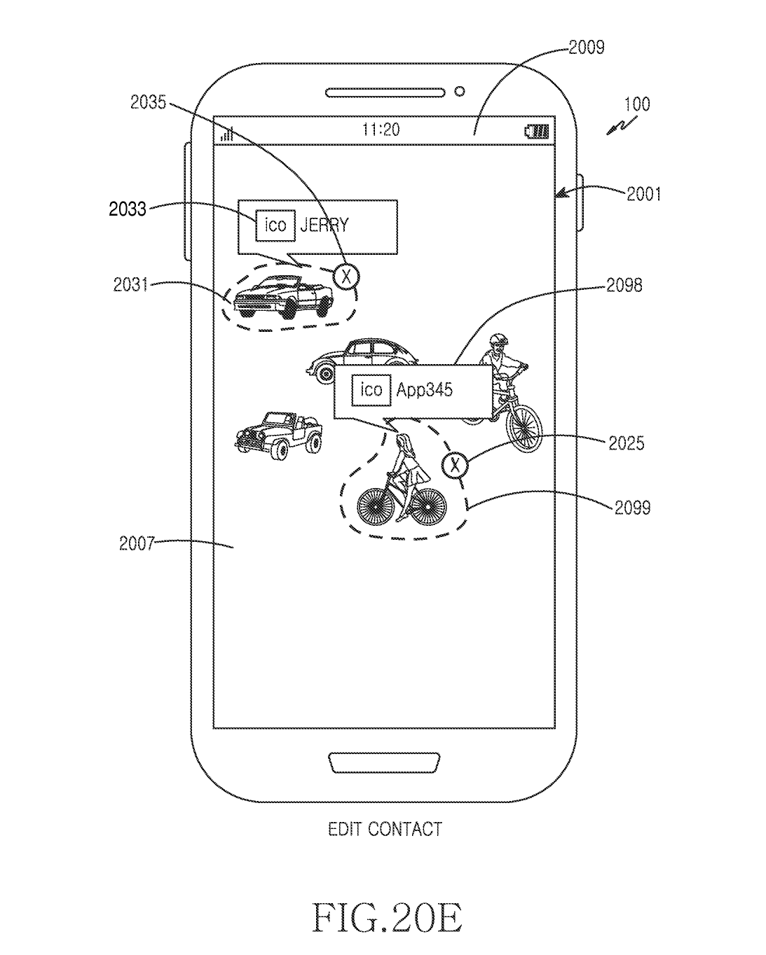

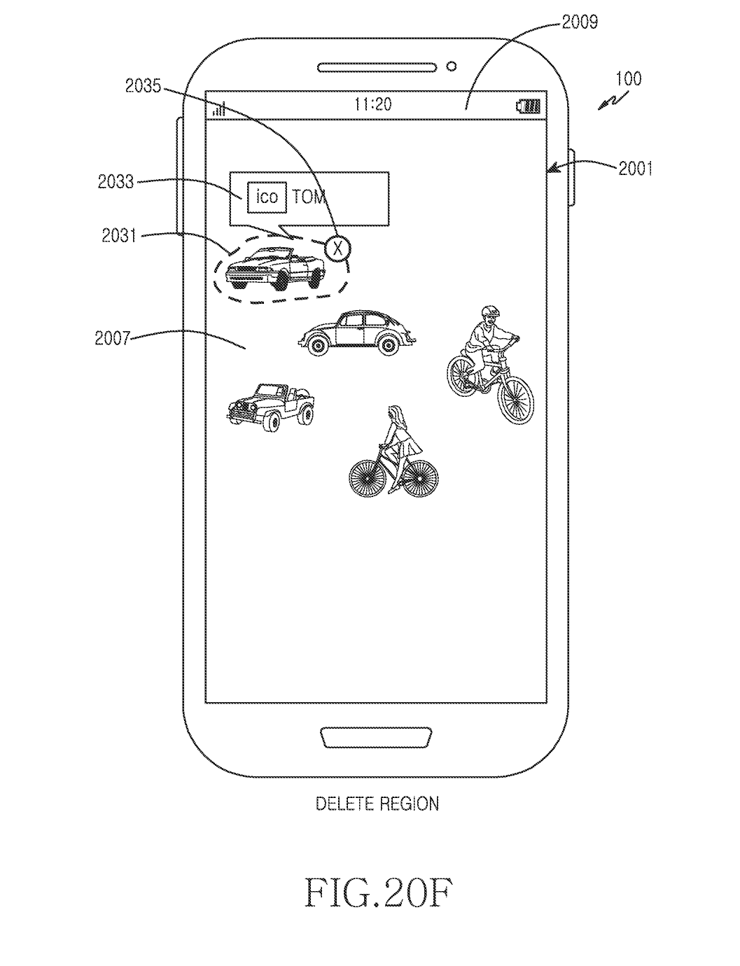

FIG. 13A is a flowchart illustrating a procedure for editing a home screen in an electronic device according to an embodiment of the present disclosure; FIGS. 14A, 14B, 14C, 14D, 14E, and 14F are views illustrating a screen configuration for editing a home screen in an electronic device according to an embodiment of the present disclosure; and FIGS. 20A, 20B, 20C, 20D, 20E, and 20F are views illustrating a screen configuration for editing a home screen in an electronic device according to an embodiment of the present disclosure.

Referring to FIG. 13A, the electronic device 100 determines whether a home screen editing event occurs in operation 1301. For example, when a menu button 1411 and/or a menu button 2011 is selected by a user, as respectively shown in FIGS. 14A and 20A, the electronic device 100 may display a menu list 1421 and/or a menu list 2021 in a pop-up window as respectively shown in FIGS. 14B and 20B. At this point, a home screen editing item 1423 and/or a home screen editing item 2023 is respectively selected from the menu list 1421 and/or the menu list 2021, the electronic device 100 recognizes that a home screen is edited. If a home screen editing event does not occur, the electronic device 100 terminates this algorithm illustrated in FIG. 13A.

Moreover, when a home screen editing event occurs, the electronic device 100 displays an area including a link in operation 1303. For example, the electronic device may display a first area 1499 and/or a first area 2099 and a second area 1431 and/or the second area 2031 including a link, as respectively shown in FIGS. 14C and 20C. At this point, the electronic device 100 may display, as indicated by icon 1498 and/or icon 2098, an icon and/or name of an application linked to the first area 1499 and/or the first area 2021, and may display an icon 1425 or an icon 2025 for releasing the selection of the first area 1499 and/or the first area 2098. Additionally, the electronic device 100 may display, as indicated by icon 1433 and/or icon 2033, an icon and/or name of a contact linked to the second area 1431 and/or the second area 2031 and may display an icon 1435 or an icon 2035 for releasing the selection of the second area 1431 or the second area 2031, as respectively shown in FIGS. 14C and 20C.

The electronic device 100 determines whether a link changing event occurs in operation 1305. For example, the electronic device 100 may determine which area is selected from the first area 1499 and/or the first area 2098 and the second area 1431 and/or the second area 2031, as respectively shown in FIGS. 14C and 20C. If the link changing event does not occur, the electronic device 100 determines whether the home screen editing event is terminated in operation 1313. Additionally, when an area is not selected, the electronic device 100 may continuously determine whether an area is selected. Moreover, when an area is not selected, the electronic device 100 determines which area is selected for a reference time and when an area is not selected for the reference time, the electronic device 100 may determine whether a home screen editing event is terminated.

Moreover, when the link changing event occurs, the electronic device 100 displays an item linkable to the area in operation 1307. For example, when the second area 1431 and/or the second area 2031 is selected, as respectively shown in FIG. 14C and 20C, the electronic device 100 determines that the icon 1433 and/or the icon 2033 linked to the second area 1431 and/or the second area 2031 changes into another content. Accordingly, the electronic device 100 may display a content linkable to the second area 1431 and/or the second area 2031. Here, the linkable content may include at least one application, at least one contact, and at least one bookmark.

Then, the electronic device 100 determines whether an item, and/or which item, is selected in operation 1309. For example, the electronic device 100 may determine whether an item is selected from contents linkable to the second area 1431 and/or the second area 2031, as is respectively shown in FIG. 14C and 20C.

If an item is not selected in operation 1309, the electronic device 100 determines whether the home screen modifying event is terminated in operation 1313.

Moreover, if the item is selected, the electronic device 100 links the item to an area in operation 1311. For example, when an address book is selected from linkable contents, the electronic device 100 may display an address book list 1441 and/or an address book list 2041, as respectively shown in FIGS. 14D and 20D. If “JERRY” 1443 and/or “JERRY” 2043 is selected, the electronic device 100 respectively links “JERRY” 1431 and/or “JERRY” 2031 to the second area 1431 and/or the second area 2031, as respectively shown in FIGS. 14E and 20E. At this point, the electronic device 100 may display an icon and/or name of a contact and/or item linked to the second area 1431 and/or the second area 2031. Additionally, the electronic device 100 may change at least one of an icon and/or name of a contact and/or an item linked to the second area 1431 and/or the second area 2031. Additionally, the electronic device 100 may release the display of at least one of an icon and/or name of a contact and/or an item linked to the second area 1431 and/or the second area 2031.

Then, the electronic device 100 determines whether to terminate the home screen editing event in operation 1313. If the home screen editing event is not terminated, the electronic device 100 maintains the display of an area including a link in operation 1303. Moreover, when the home screen editing event is terminated, the electronic device 100 displays a home screen in operation 1315. For example, when the home screen modifying event is terminated, the electronic device 100 may display a home screen as shown in FIGS. 14A and 20A. At this point, the electronic device 100 may display an area including a link among areas included in a home screen. Additionally, when a specific operation, for example, the hovering operation, occurs by using an electronic pen during the display of the home screen, the electronic device 100 may display an area including a link among areas included in the home screen.

Then, the electronic device terminates this algorithm illustrated in FIG. 13A. Additionally, as shown in FIG. 14A, the electronic device 100 may include a display unit 1401, and may display a wallpaper 1407, a status bar 1409, at least one application 1403, and a page display area 1405. Also, as shown in FIG. 20A, the electronic device 100 may include a display unit 2001, and may display a wallpaper 2007, and a status bar 2009.

FIG. 13B is a flowchart illustrating a procedure for modifying a home screen in an electronic device according to an embodiment of the present disclosure.

Referring to FIG. 13B, the electronic device 100 determines whether a home screen editing event occurs in operation 1321. For example, when the menu button 1411 and/or the menu button 2011 is selected by a user, as respectively shown in FIGS. 14A and 20A, the electronic device 100 may display the menu list 1421 and/or the menu list 2021 in a pop-up window, as respectively shown in FIGS. 14B and 20B. At this point, the home screen editing item 1423 and/or the home screen editing item 2023 is respectively selected from the menu list 1421 and/or the menu list 2021, and the electronic device 100 determines that a home screen is edited. If a home screen editing event does not occur, the electronic device 100 terminates this algorithm illustrated in FIG. 13B.

Moreover, when a home screen editing event occurs, the electronic device 100 displays an area including a link in operation 1323. For example, the electronic device 100 may display the first area 1421 and/or the first area 2021 and the second area 1431 and/or the second area 2031 including a link, as respectively shown in FIGS. 14C and 20C. At this point, the electronic device 100 may display, as indicated by the icon 1498 and/or the icon 2098, an icon and/or name of an application linked to the first area 1421 and/or the first area 2021 and may display an icon 1425 and/or an icon 2025 for releasing the selection of the first area 1421 and/or the first area 2021. Additionally, the electronic device 100 may display, as indicated by the icon 1433 and/or the icon 2033, an icon or name of a contact linked to the second area 1431 and/or the second area 2031 and may display the icon 1435 and/or the icon 2035 for releasing the selection of the second area 1431 and/or the second area 2031.

Then, the electronic device 100 determines whether an event for releasing the selection of an area occurs in operation 1325. For example, the electronic device may determine which icon is selected from the icon 1425 and/or the icon 2025 for releasing the selection of the first area 1421 and/or the first area 2021 and the icon 1435 and/or the icon 2035 for releasing the selection of the second area 1431 and/or the second area 2031, as respectively shown in FIGS. 14C and 20C. If the event for releasing the selection of an area does not occur, the electronic device 100 determines whether the home screen modifying event is terminated in operation 1329. Additionally, if the event for releasing the selection of an area does not occur, the electronic device 100 may continuously determine whether an icon for releasing the selection of at least one area is selected. Moreover, if the event for releasing the selection of an area does not occur, the electronic device 100 may determine whether an icon for releasing the selection of at least one area is selected for, and/or during, a reference time, and if the icon for releasing the selection of at least one area is not selected for, and/or during, the reference time, the electronic device 100 may determine whether the home screen editing event is terminated.

Moreover, when the event for releasing the selection of an area occurs, the electronic device 100 releases the selection of the area based on selection of the icon in operation 1327. For example, when the icon 1425 and/or the icon 2025, for releasing the selection of the first area 1421 and/or the first area 2021, as respectively shown in FIGS. 14C and 20C is selected, the electronic device 100 may release the selection of the first area 1421 and/or the first area 2021, and may display the second area 1431 and/or the second area 2031, as respectively shown in FIGS. 14F and 20F.

Although the selection of an area is released based on the selection of the icon 1425 and/or the icon 2025 for releasing the selection of an area, and thus a content connected to an area is released, the present disclosure is not limited thereto. For example, while the selected area is maintained, only a connection of content and/or an item may be released.

For this, an icon for releasing the connection of the content and/or the item may be additionally displayed. Additionally, once the icon 1425 or the icon 2025 is selected, a screen for receiving a selection on whether the selection of an area is released or the connection of a content connected to an area is released may be displayed.

Moreover, when only the connection of a content is released, a marker and/or identifier, for example, a closed curve surrounding the area, for identifying an area on the basis of at least one input of a user's menu operation, a touch input, and a hovering input may be displayed. By using such a method, a user may make an image as a template.

The electronic device 100 determines whether to terminate the home screen editing event in operation 1329. If the home screen editing event is not terminated, the electronic device 100 maintains the display of an area including a link in operation 1323.

Moreover, when the home screen editing event is terminated, the electronic device 100 displays a home screen in operation 1331. For example, when the home screen modifying event is terminated, the electronic device 100 may display a home screen as shown in FIGS. 14A and 20A. At this point, the electronic device 100 may display an area including a link among areas included in a home screen. Additionally, when a specific operation, for example, the hovering operation, occurs by using an electronic pen during the display of the home screen, the electronic device 100 may display an area including a link among areas included in the home screen.

Then, the electronic device terminates this algorithm illustrated in FIG. 13B.

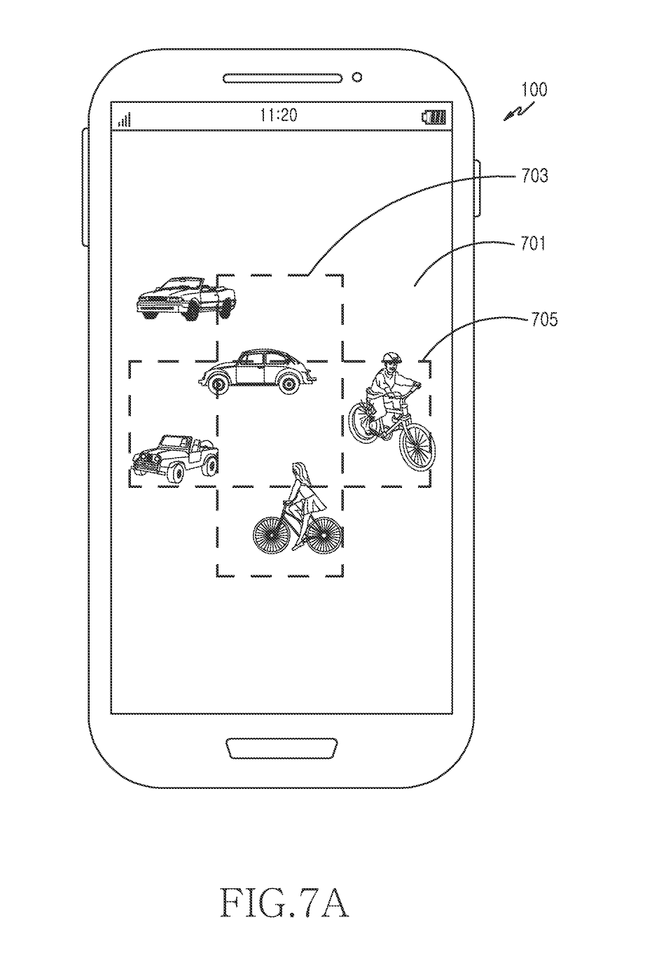

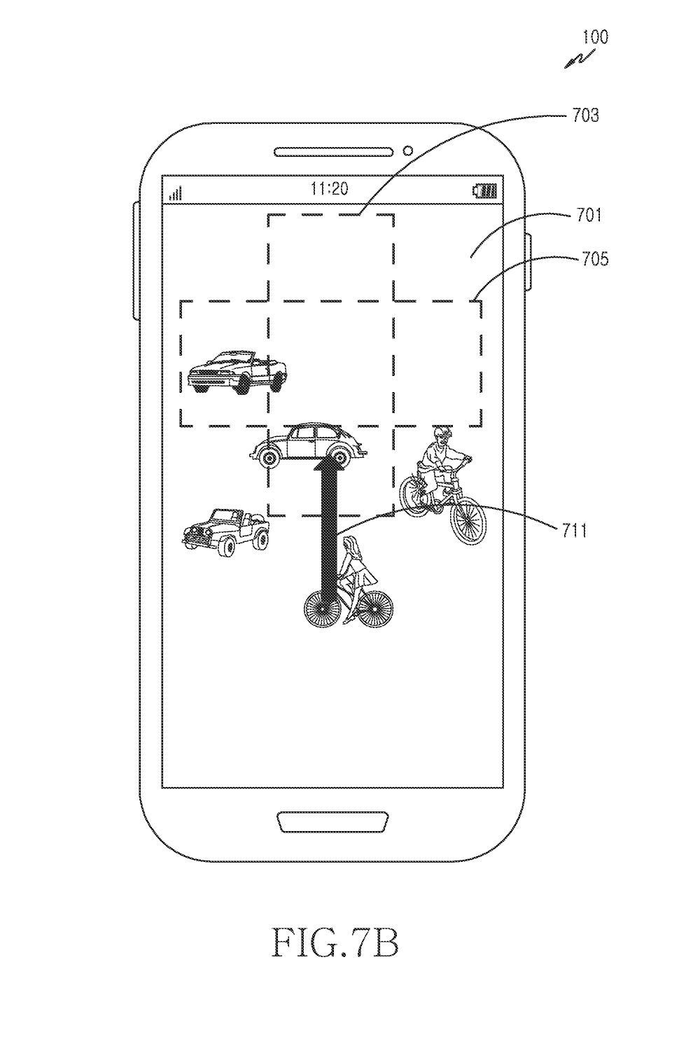

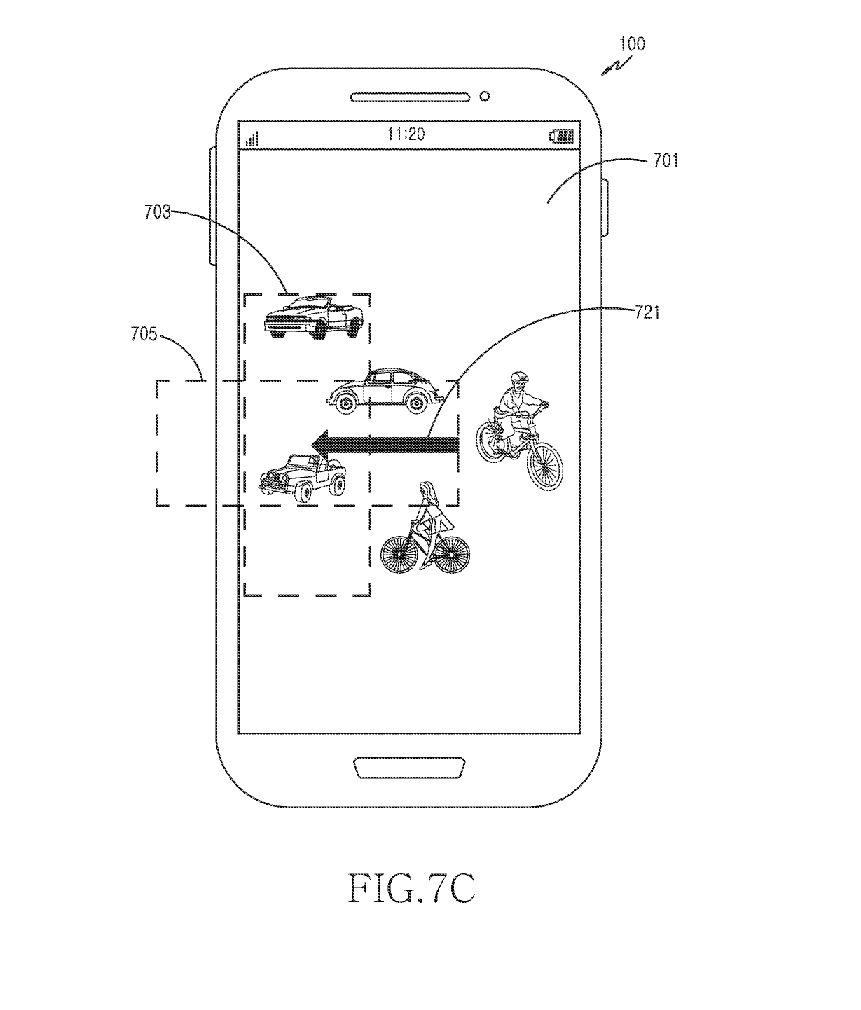

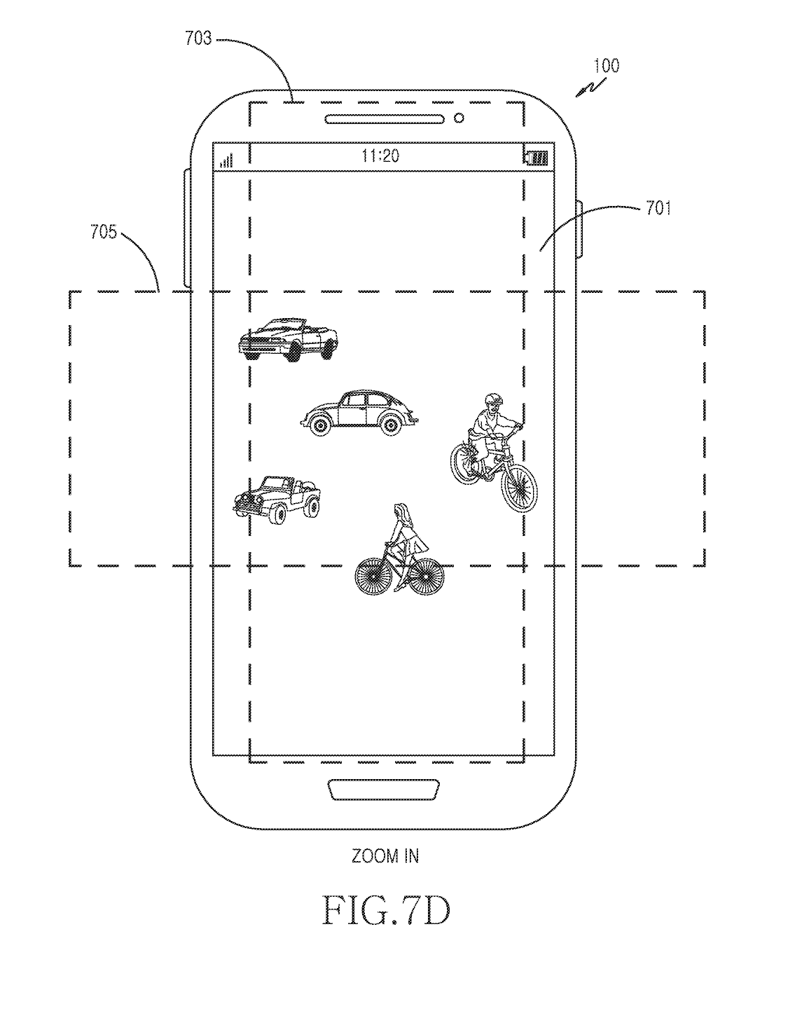

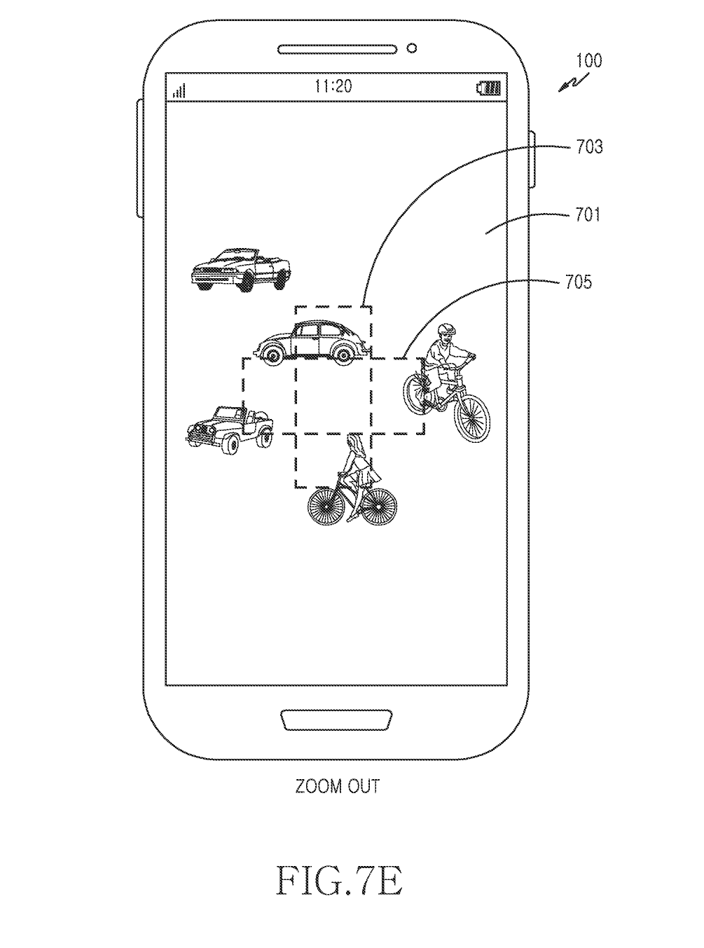

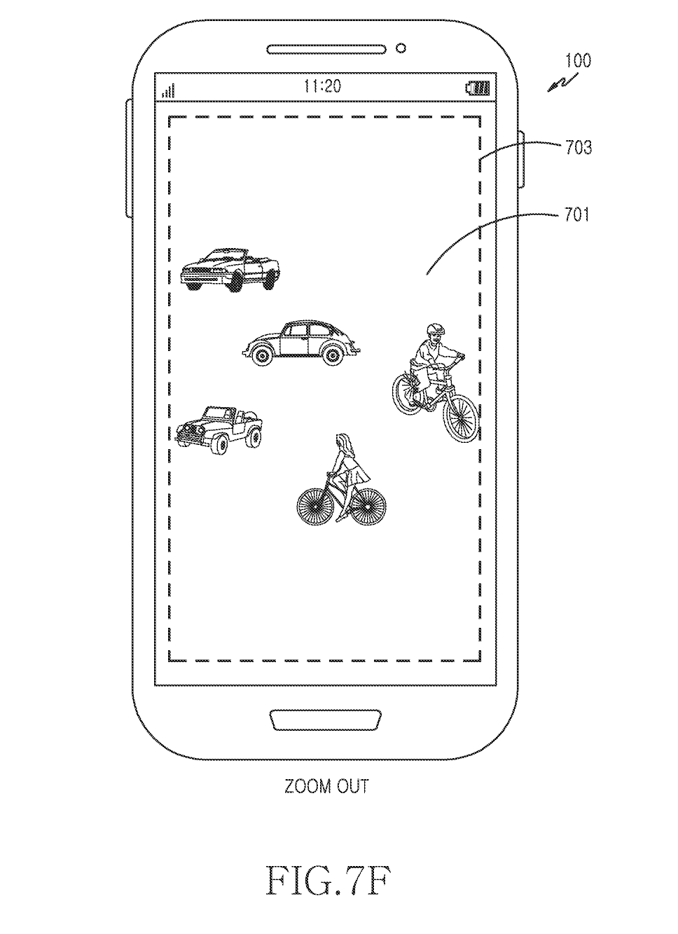

FIGS. 7A to 7F are views illustrating a screen configuration for setting at least one of a size, a position, and a tilt of a wallpaper set on a home screen in an electronic device according to an embodiment of the present disclosure.

Referring to FIG. 7A, the electronic device 100 may change at least one of the size, for example, enlarge or reduce, the position, for example, top, bottom, left, and right, and the tilt, for example, an angle, of a wallpaper 701 used as the home screen. At this point, the electronic device 100 may display a first guide area 705 for a landscape mode and/or a second guide area 703 for a portrait mode. At this point, the electronic device 100 may display an indicator for controlling the first guide area 705 and/or the second guide area 703. FIG. 7B is a screen configuration when the first guide area 705 and/or the second guide area 703, as shown in FIG. 7A, moves towards a top direction 711, and FIG. 7C is a screen configuration when the first guide area 705 and/or the second guide area 703, as shown in FIG. 7A, moves towards a left direction 721. FIG. 7D is a screen configuration when the first guide area 705 and/or the second guide area 703, as shown in FIG. 7A, is enlarged, and FIG. 7E is a screen configuration when the first guide area 705 and/or the second guide area 703, as shown in FIG. 7A, is reduced. FIG. 7E is a screen configuration when only the second guide area 703 is selected from among the first guide area 705 and the second guide area 703, as shown in FIG. 7A. At least one of the top direction 711 and the left direction 721 may correspond to and/or be selected according to a trajectory of a user input.

According to an embodiment of the present disclosure, an electronic device connects at least one content and/or item to a wallpaper. According to another embodiment of the present disclosure, when a selection event on an area occurs, the electronic device may play content connected to the area.

According to an embodiment of the present disclosure, although an electronic device configures a home screen with at least one wallpaper, the present disclosure is not limited thereto. Thus, at least one wallpaper may be configured on a lock screen.

As mentioned above, an area is determined from a wallpaper of a home screen in an electronic device and a content connection and/or a link connection to a predetermined area is provided, so that the electronic device may provide a high degree of freedom in a home screen configuration of a user.

It will be appreciated that various embodiments of the present disclosure according to the claims and description in the specification can be realized in the form of hardware, software or a combination of hardware and software. Any such software may be stored in a non-transient computer readable storage medium. The non-transient computer readable storage medium stores one or more programs (software modules), the one or more programs comprising instructions, which when executed by one or more processors in an electronic device, cause the electronic device to perform a method of the present disclosure. Any such software may be stored in the form of volatile or non-volatile storage medium such as, for example, a storage device like a ROM, whether erasable or rewritable or not, or in the form of memory such as, for example, RAM, memory chips, a hardware device and/or integrated circuits and/or on an optically and/or magnetically readable medium such as, for example, a compact disk (CD), a digital versatile disk (DVD), a magnetic disk and/or magnetic tape and/or the like. It will be appreciated that the storage devices and storage media are various embodiments of machine-readable storage that are suitable for storing a program or programs comprising instructions that, when executed, implement various embodiments of the present disclosure. Accordingly, various embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and various embodiments suitably encompass the same.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device to configure a screen, the method comprising:
determining at least one area in a wallpaper displayed on the electronic device;
selecting at least one content to be connected to the at least one determined area; and
connecting the at least one selected content to the at least one determined area.

2. The method of claim 1, further comprising determining a wallpaper for at least one of a lock screen and a home screen.

3. The method of claim 1, wherein the wallpaper comprises at least one of an image, a document, a webpage, and a video from at least one application providing at least one of a template stored in the electronic device and a wallpaper setting.

4. The method of claim 1, wherein the at least one content comprises at least one of at least one application in the electronic device, at least one contact, and at least one bookmark.

5. The method of claim 1, wherein the determining of the at least one area comprises:
when the background is a template, displaying at least one area in the template; and
determining which area is selected from the at least one displayed area.

6. The method of claim 1, wherein the determining of the at least one area comprises determining the at least one area on the basis of at least one trajectory from among a touch input and a hovering input for the wallpaper.

7. The method of claim 1, further comprising changing at least one of a size of the wallpaper and a size of the at least one determined area on the basis of at least one of a menu operation, a touch input, and a hovering input.

8. The method of claim 1, wherein the connecting of the at least one selected content to the at least one determined area comprises:
displaying a list of contents connectable to the at least one determined area; and
connecting at least one content selected from the content list to the at least one determined area.

9. The method of claim 1, wherein the connecting of the at least one selected content to the at least one determined area comprises displaying at least one of an icon and name of a content connected to the at least one determined area and a mark for identifying the at least one determined area.

10. The method of claim 9, further comprising displaying an icon and name of a content connected to the at least one determined area and a mark for identifying the at least one determined area on the basis of at least one of an input of a menu operation, a touch input, and a hovering input.

11. The method of claim 1, further comprising, when an editing event for a content connected to the at least one determined area occurs on the basis of at least one of an input of a menu operation, a touch input, and a hovering input, releasing a connection of the content connected to the at least one determined area or connecting another content to the at least one determined area.

12. The method of claim 1, further comprising, when an editing event for the at least one determined area occurs on the basis of at least one of an input of a menu operation, a touch input, and a hovering input, releasing a selection of the at least one determined area or at least one of moving, enlarging, reducing, and rotating the at least one determined area.

13. The method of claim 1, further comprising, when a selection event for the at least one determined area occurs, executing a function relating to a content connected to the at least one determined area.

14. An electronic device comprising:
a display; and
a processor configured to determine at least one area from a wallpaper displayed on the electronic device, to select at least one content to be connected to the at least one determined area, and to connect the at least one selected content to the at least one determined area.

15. The device of claim 14, wherein, when the wallpaper is a template, the processor is configured to display at least one predefined area in the template, and
wherein, when at least one determined area is selected from the at least one displayed area, the processor is configured to determine the at least one selected area as the at least one determined area.

16. The device of claim 14, wherein the processor is configured to determine the at least one determined area on the basis of at least one trajectory from among a touch input and a hovering input for the wallpaper.

17. The device of claim 14, wherein the processor is configured to display a list of contents connectable to the at least one determined area, and
wherein the process or is configured to connect at least one content selected from the content list to the at least one determined area.

18. The device of claim 14, wherein the processor is configured to display at least one of an icon and name of a content connected to the at least one determined area and a mark for identifying the at least one determined area.

19. The device of claim 14, wherein the processor is configured to, when an editing event for a content connected to the at least one determined area occurs on the basis of at least one input of a menu operation, a touch input, and a hovering input, release a connection of the content connected to the at least one determined area or connects another content to the at least one determined area.

20. The device of claim 14, wherein the processor is configured to, when a selection event for the at least one determined area occurs, perform a function relating to the content connected to the at least one determined area.
